(19) United States
(12) Patent Application Publication
(10) Pub. No.: US 2026/0245433 A1
(43) Pub. Date: Aug. 20, 2026

(54) SYSTEMS AND METHODS FOR TRIGGERING BONUS FEATURES OF ELECTRONIC WAGERING GAMES

(71) Applicant: Aristocrat Technologies, Inc., Las Vegas, NV (US)

(72) Inventors: Nicholas Farina, Granger, IN (US); Sara LaRocca, JR., Reno, NV (US); Vincent Smith, Las Vegas, NV (US); Jennifer Mizzi, Ewa Beach, HI (US)

(21) Appl. No.: 19/057,787

(22) Filed: Feb. 19, 2025

(51) Int. Cl. G07F 17/32

(52) U.S. Cl. CPC G07F 17/3267; G07F 17/3213

(57) ABSTRACT

A system for triggering bonus features of an electronic wagering game may include a display device and circuitry. The circuitry may be configured to detect, in a base game, an event that triggers incrementing a bonus feature trigger meter. Based on detecting the event, the circuitry may determine a random number of steps between zero steps and one less than all remaining steps to fill the bonus feature trigger meter. The bonus feature trigger meter may be incremented by the determined random number of steps, and the circuitry may cause the display device to display the incremented bonus feature trigger meter. When the bonus feature trigger meter is filled, the circuitry may cause the display device to display a bonus feature. Various other systems and methods are also disclosed.

### BACKGROUND

Electronic gaming machines (“EGMs”) or gaming devices provide a variety of wagering games such as slot games, video poker games, video blackjack games, roulette games, video bingo games, keno games, and other types of games that are frequently offered at casinos and other locations. Play on EGMs typically involves a player establishing a credit balance by inputting money, or another form of monetary credit, and placing a monetary wager (from the credit balance) on one or more outcomes of an instance (or single play) of a primary or base game. In some cases, a player may qualify for a special mode of the base game, a secondary (e.g., bonus) game, or a bonus round of the base game by attaining a certain winning combination or triggering event in, or related to, the base game, or after the player is randomly awarded the special mode, secondary game, or bonus round. In the special mode, secondary game, or bonus round, the player is given an opportunity to win extra game credits, game tokens or other forms of payout. In the case of “game credits” that are awarded during play, the game credits are typically added to a credit meter total on the EGM and can be provided to the player upon completion of a gaming session or when the player wants to “cash out.”

“Slot” type games are often displayed to the player in the form of various symbols arrayed in a row-by-column grid or matrix. Specific matching combinations of symbols, such as along predetermined paths (or paylines) through the matrix, indicate the outcome of the game. The display typically highlights winning combinations/outcomes for identification by the player. Matching combinations and their corresponding awards are usually shown in a “pay table” which is available to the player for reference. Often, the player may vary his/her wager to include differing numbers of paylines and/or the amount bet on each line. By varying the wager, the player may sometimes alter the frequency or number of winning combinations, frequency or number of secondary games, and/or the amount awarded.

Casinos and other gaming establishments typically have multiple different types of electronic wagering games. Some of these games include Class III games, which include traditional slot type games or matching games. Other gaming establishments may provide Class II games, which are typically bingo-based games.

Typical games use a random number generator (RNG) to randomly determine the outcome of each game and/or game round. The game is designed to return a certain percentage of the amount wagered back to the player over the course of many plays or instances of the game, which is generally referred to as return to player (RTP). The RTP and randomness of the RNG ensure the fairness of the games and are highly regulated. Upon initiation of play, the RNG randomly determines a game or round outcome and symbols are then selected corresponding to that outcome. Notably, some games may include an element of skill on the part of the player and are therefore not entirely random.

### SUMMARY

As will be described in greater detail below, the instant disclosure generally relates to systems and methods for triggering bonus features of electronic wagering games.

In some aspects, the techniques described herein relate to a system, including: a display device; and circuitry configured to: detect, in a base game of an electronic wagering game displayed on the display device, an event that triggers incrementing a bonus feature trigger meter; based on detecting the event, determine a random number of steps between zero steps and one less than all remaining steps to fill the bonus feature trigger meter; increment the bonus feature trigger meter by the determined random number of steps; cause the display device to display the incremented bonus feature trigger meter; and when the bonus feature trigger meter is filled, cause the display device to display a bonus feature.

In some aspects, the techniques described herein relate to a system, wherein the circuitry is further configured to, in connection with the base game: cause the display device to display random symbols from a set of symbols on one or more reels of the electronic wagering game.

In some aspects, the techniques described herein relate to a system, wherein the event that triggers incrementing the bonus feature trigger meter includes the display device displaying at least one of the random symbols that is a bonus symbol.

In some aspects, the techniques described herein relate to a system, wherein the one or more reels includes at least three reels.

In some aspects, the techniques described herein relate to a system, wherein the circuitry is further configured to, in connection with the base game: cause the electronic wagering game to credit to a user one or more values represented by one or more award symbols of the random symbols displayed on the one or more reels by the display device.

In some aspects, the techniques described herein relate to a system, wherein causing the display device to display the bonus feature includes causing the display device to: display a bonus wheel including enhancement symbols; and randomly select one or more of the enhancement symbols of the bonus wheel.

In some aspects, the techniques described herein relate to a system, wherein the circuitry is further configured to, after randomly selecting the one or more enhancement symbols: cause the display device to display a bonus game with one or more enhancements applied corresponding to the selected one or more enhancement symbols of the bonus wheel.

In some aspects, the techniques described herein relate to a system including: a display device; and circuitry configured to: detect, in a base game of an electronic wagering game displayed on the display device, one or more random events that trigger incrementing at least one of a first trigger meter for a first bonus feature or a second trigger meter for a second bonus feature; based on detecting the one or more random events, increment the first trigger meter until the first trigger meter is filled to trigger the first bonus feature; when the first bonus feature is triggered, cause the display device to display first enhancement symbols including at least one activation symbol to activate the second bonus feature; when the second bonus feature is activated, cause the display device to display second enhancement symbols; determine a random one of the first enhancement symbols of the first bonus feature for selection; and cause the display device to display a bonus game with a first enhancement based on the selected one of the first enhancement symbols applied.

In some aspects, the techniques described herein relate to a system, wherein causing the display device to display the first enhancement symbols includes causing the display device to display a first bonus wheel including the first enhancement symbols.

In some aspects, the techniques described herein relate to a system, wherein the circuitry is further configured to: when the second bonus feature is activated, randomly select one of the second enhancement symbols of the second bonus feature; and cause the display device to display the bonus game with a second enhancement based on the selected one of the second enhancement symbols applied.

In some aspects, the techniques described herein relate to a system, wherein the first enhancement symbols include symbols representing one of: advancement toward improved chances for higher payouts in the bonus game, one or more additional rows of bonus symbols in the bonus game, or one or more additional rounds of the bonus game.

In some aspects, the techniques described herein relate to a system, wherein the second enhancement symbols include symbols representing a different one of: the advancement toward improved chances for higher payouts in the bonus game, the one or more additional rows of bonus symbols in the bonus game, or the one or more additional rounds of the bonus game.

In some aspects, the techniques described herein relate to a system, wherein the circuitry is further configured to, in connection with the bonus game: cause the display device to display random symbols from a set of bonus symbols on one or more bonus reels of the electronic wagering game.

In some aspects, the techniques described herein relate to a computer-implemented method, including: detecting, by circuitry during a base game of an electronic wagering game displayed on a display device, an event that triggers incrementing a bonus feature trigger meter; determining, by the circuitry and based on detecting the event, a random number of steps between zero steps and one less than all remaining steps to fill the bonus feature trigger meter; incrementing, by the circuitry, the bonus feature trigger meter by the determined random number of steps; causing, by the circuitry, the display device to display the incremented bonus feature trigger meter; and causing, by the circuitry and when the bonus feature trigger meter is filled, the display device to display a bonus feature.

In some aspects, the techniques described herein relate to a method, wherein causing the display device to display the bonus feature includes causing, by the circuitry, the display device to: display a bonus wheel including enhancement symbols; and randomly select one or more of the enhancement symbols of the bonus wheel.

In some aspects, the techniques described herein relate to a method, further including, after randomly selecting the one or more enhancement symbols, causing, by the circuitry, the display device to display a bonus game with one or more enhancements applied corresponding to the selected one or more enhancement symbols of the bonus wheel.

In some aspects, the techniques described herein relate to a method, wherein causing the display device to display the bonus feature includes: causing, by the circuitry, the display device to display first enhancement symbols including at least one activation symbol to activate an additional bonus feature; causing, by the circuitry and when the additional bonus feature is activated, the display device to display second enhancement symbols; determining, by the circuitry, a random one of the first enhancement symbols of the bonus feature for selection; and causing, by the circuitry, the display device to display a bonus game with a first enhancement based on the selected one of the first enhancement symbols applied.

In some aspects, the techniques described herein relate to a method, further including: when the second bonus feature is activated, randomly selecting, by the circuitry, one of the second enhancement symbols of the additional bonus feature; and causing, by the circuitry, the display device to display the bonus game with a second enhancement based on the selected one of the second enhancement symbols applied.

In some aspects, the techniques described herein relate to a method, wherein the first enhancement symbols include symbols representing one of: advancement toward improved chances for higher payouts in the bonus game, one or more additional rows of bonus symbols in the bonus game, or one or more additional rounds of the bonus game.

In some aspects, the techniques described herein relate to a method, wherein the second enhancement symbols include symbols representing a different one of: the advancement toward improved chances for higher payouts in the bonus game, the one or more additional rows of bonus symbols in the bonus game, or the one or more additional rounds of the bonus game.

Features from any of the above-mentioned embodiments may be used in combination with one another in accordance with the general principles described herein. These and other embodiments, features, and advantages will be more fully understood upon reading the following detailed description. While the example embodiments described herein are susceptible to various modifications and alternative forms, specific embodiments will be described in detail herein. However, the example embodiments described herein are not intended to be limited to the particular forms disclosed. Rather, the instant disclosure covers all modifications, equivalents, and alternatives falling within this disclosure.

### BRIEF DESCRIPTION OF THE DRAWINGS

The accompanying drawings illustrate a number of example embodiments and are a part of the specification. Together with the following description, these drawings demonstrate and explain various principles of the instant disclosure.

FIG. 1 is an example diagram showing several electronic gaming machines (EGMs) networked with various gaming related servers.

FIG. 2A is a block diagram showing various functional elements of an example EGM.

FIG. 2B depicts a casino gaming environment according to one example.

FIG. 2C is a diagram that shows examples of components of a system for providing online gaming according to some aspects of the present disclosure.

FIG. 3 illustrates, in block diagram form, an implementation of a game processing architecture algorithm that implements a game processing pipeline for the play of a game in accordance with various implementations described herein.

FIG. 4 is a block diagram of an example system for displaying visual effects corresponding to events that occur in connection with bonus features of electronic wagering games according to one or more implementations of this disclosure.

FIG. 5 is a block diagram of an example graphical interface of an electronic wagering game according to one or more implementations of this disclosure.

FIG. 6 is a block diagram of an example graphical interface of an electronic wagering game according to one or more implementations of this disclosure.

FIG. 7 is a block diagram of an example graphical interface of an electronic wagering game according to one or more implementations of this disclosure.

FIG. 8 is a block diagram of an example graphical interface of an electronic wagering game according to one or more implementations of this disclosure.

FIG. 9 is a block diagram of an example graphical interface of an electronic wagering game according to one or more implementations of this disclosure.

FIG. 10 is a block diagram of an example graphical interface of an electronic wagering game according to one or more implementations of this disclosure.

FIG. 11A illustrates a weight table, according to at least one embodiment of the present disclosure. FIG. 11B illustrates three weight tables, according to at least one additional embodiment of the present disclosure.

FIG. 12 is a flow diagram of an example computer-implemented method for triggering bonus features of electronic wagering games according to one or more implementations of this disclosure.

Throughout the drawings, identical reference characters and descriptions may indicate similar, but not necessarily identical, elements. While the example embodiments described herein are susceptible to various modifications and alternative forms, specific embodiments have been shown by way of example in the drawings and will be described in detail herein. However, the example embodiments described herein are not intended to be limited to the particular forms disclosed. Rather, the instant disclosure covers all modifications, equivalents, and alternatives falling within the scope of the appended claims.

### DETAILED DESCRIPTION

Embodiments of the instant disclosure are generally directed to systems and methods for triggering bonus features of electronic wagering games. Some electronic wagering systems may suffer from certain technical problems and/or deficiencies that impair users'experiences and/or enjoyment. For example, insufficient ways or opportunities for a player to reach bonus features may result in a lack of engagement. The electronic gaming systems and methods described herein may address, resolve, and/or mitigate some of these technical problems and/or deficiencies. For example, triggering bonus features (e.g., side games, free games, additional rounds of gameplay, enhanced gameplay, etc.) can be an exciting and engaging part of gameplay. The present disclosure identifies and describes improved ways for triggering bonus features that may have a random aspect while maintaining engagement and enjoyment of the gameplay.

In some examples, the disclosed systems may include and/or represent an EGM having a display, one or more input devices, a wager acceptor, and/or a game controller coupled to the display, the input devices, and/or the wager acceptor. The game controller may be or include circuitry that is configured to control the display to present and/or display an electronic wagering game. The game controller may present and/or display these various wager options in the electronic wagering game.

In some examples, the electronic wagering game may be governed by different rules and/or pay tables. In one example, the game controller may be configured to operate the electronic wagering game using a common wagering event (e.g., a reel spin). The game controller may also enable users to make certain selections (e.g., wager selections) in the electronic wagering game.

In some examples, an electronic wagering system may implement a graphical slot machine that includes and/or represents a set of reels that spin in connection with a user's wager. In one example, the graphical slot machine may include and/or represent a set of metamorphic visuals (e.g., rows of gems that can be highlighted, flame graphics that grow in size and/or intensity, graphical bowls that fill with graphical coins, etc.) whose status and/or condition depicts the user's apparent progress toward triggering a bonus feature, such as one or more bonus wheels and a bonus game that applies one or more enhancements from the bonus wheel(s).

In some examples, the bonus feature may be triggered by one or more events of a base game displayed on the graphical slot machine, such as one or more bonus trigger symbols landing on reels of the graphical slot machine. Which symbols land on the graphical slot machine may be based, at least in part, on random number generation. For example, an RNG of or associated with the game controller may be used to determine which symbols land on the reels. If a bonus trigger symbol lands on the reels, then a bonus feature trigger meter may be incremented by a random number (e.g., using the RNG) between zero steps and one less than all steps remaining to fill the bonus feature trigger meter. Accordingly, the bonus feature trigger meter may be incremented zero steps, a single step, all steps to become filled, or any number of steps therebetween. If the bonus feature trigger meter reaches its filled state, a bonus feature may be triggered.

In some examples, the bonus feature may include two portions: one or more bonus wheels for selecting (e.g., randomly selecting) one or more enhancements for a bonus game, and the bonus game with the one or more enhancements applied. In some implementations with multiple potential bonus wheels, one bonus wheel or multiple bonus wheels may be triggered during a single bonus feature. In one example, two or more bonus wheels may be triggered based on an event during the base game, such as two or more respective bonus trigger symbols landing on the reels of the graphical slot machine. Additionally or alternatively, one or more additional bonus wheels may be triggered based on an event during implementation of an initial bonus wheel, such as by landing on an additional bonus wheel symbol of the initial bonus wheel. Accordingly, in some examples, multiple bonus wheels and corresponding enhancements for the bonus game may be activated in potentially multiple ways.

In some examples of the base game and/or the bonus game, the game controller may cause reels of the graphical slot machine to display one or more symbols that potentially provide a benefit to the player. The number and placement of such beneficial symbols may be controlled by the game controller. For example, if the RNG determines that two or more of the beneficial symbols should be landed and displayed during a particular round of gameplay, then the two or more of the beneficial symbols may be grouped and positioned together. Positioning these beneficial symbols together may increase engagement and excitement for players.

In certain implementations, as part of the base game and/or bonus game, the graphical slot machine may give the value of cash-on-reel (COR) symbols appearing on the reels to the user before the bonus feature ends.

In some examples, each COR symbol that appears on the reels during the implementation of base game and/or bonus game may correspond to and/or represent at least one value (e.g., a monetary value and/or credit). In some examples, the player may be awarded the value associated with each COR symbol in response to another activation symbol (e.g., an ignite symbol) also landing during a round of gameplay.

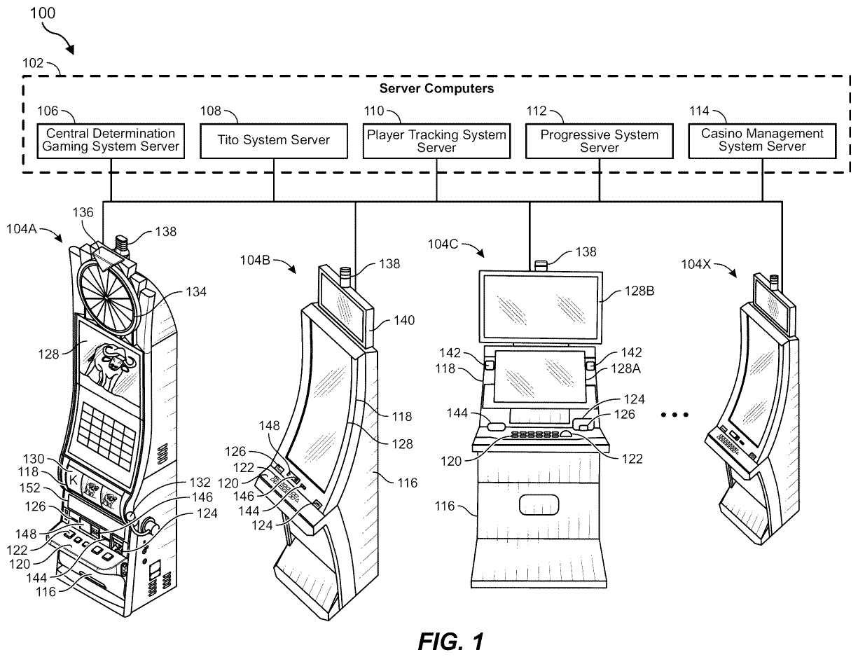

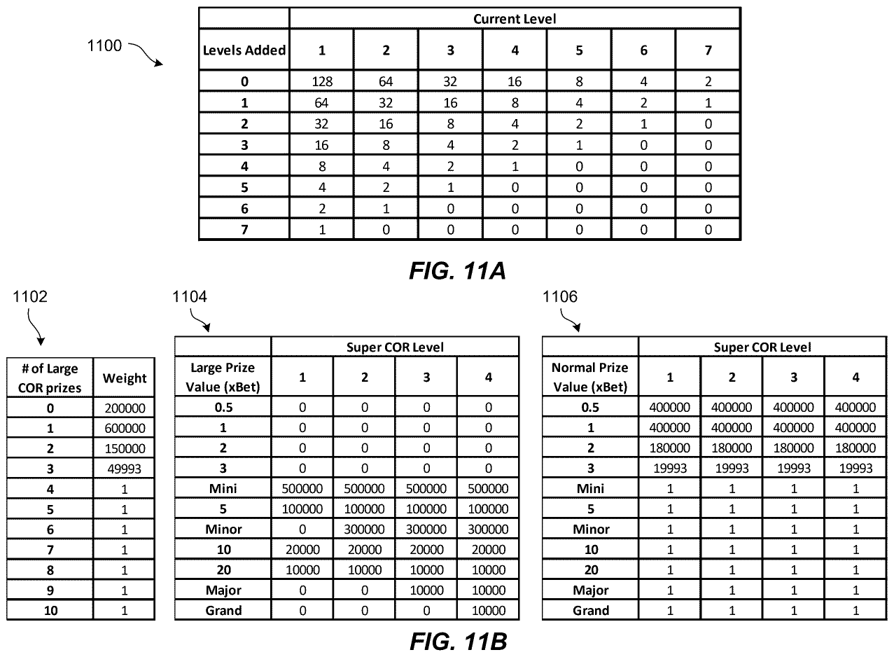

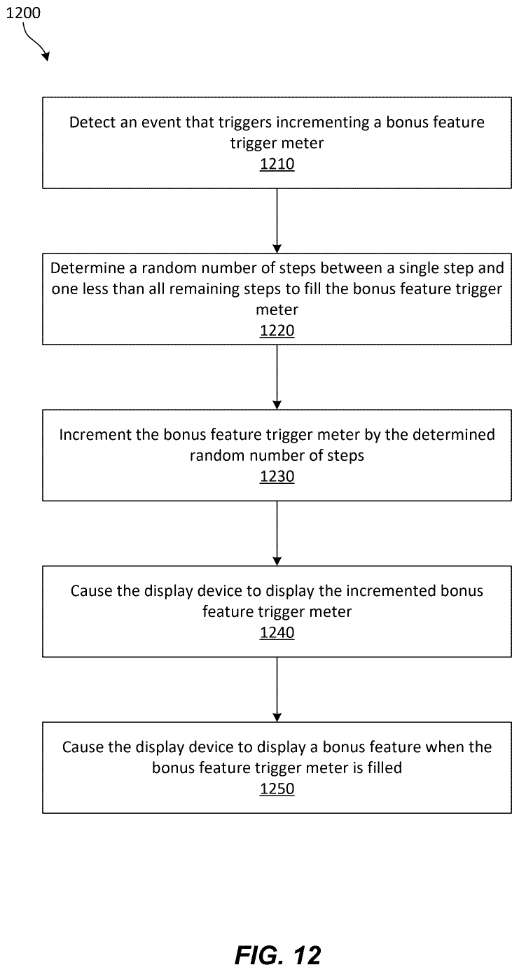

The following will provide, with reference to FIGS. 1-10, detailed descriptions of example apparatuses, devices, systems, components, configurations, features, and/or implementations for triggering bonus features of electronic wagering games. With reference to FIGS. 11A and 11B, weight tables that may be used in conjunction with a random number generator to attain various results will then be discussed. In addition, detailed descriptions of methods for triggering bonus features of electronic wagering games will be provided in connection with FIG. 12.

FIG. 1 illustrates several different models of EGMs which may be networked to various gaming related servers. Shown is a system 100 in a gaming environment including one or more server computers 102 (e.g., slot servers of a casino) that are in communication, via a communications network, with one or more gaming devices 104A-104X (EGMs, slots, video poker, bingo machines, etc.) that can implement one or more aspects of the present disclosure. The gaming devices 104A-104X may alternatively be portable and/or remote gaming devices such as, but not limited to, a smart phone, a tablet, a laptop, or a game console. Gaming devices 104A-104X utilize specialized software and/or hardware to form non-generic, particular machines or apparatuses that comply with regulatory requirements regarding devices used for wagering or games of chance that provide monetary awards.

Communication between the gaming devices 104A-104X and the server computers 102, and among the gaming devices 104A-104X, may be direct or indirect using one or more communication protocols. As an example, gaming devices 104A-104X and the server computers 102 can communicate over one or more communication networks, such as over the Internet through a website maintained by a computer on a remote server or over an online data network including commercial online service providers, Internet service providers, private networks (e.g., local area networks and enterprise networks), and the like (e.g., wide area networks). The communication networks could allow gaming devices 104A-104X to communicate with one another and/or the server computers 102 using a variety of communication-based technologies, such as radio frequency (RF) (e.g., wireless fidelity (WiFi®) and Bluetooth®), cable TV, satellite links and the like.

In some implementation, server computers 102 may not be necessary and/or preferred. For example, in one or more implementations, a stand-alone gaming device such as gaming device 104A, gaming device 104B or any of the other gaming devices 104C-104X can implement one or more aspects of the present disclosure. However, it is typical to find multiple EGMs connected to networks implemented with one or more of the different server computers 102 described herein.

The server computers 102 may include a central determination gaming system server 106, a ticket-in-ticket-out (TITO) system server 108, a player tracking system server 110, a progressive system server 112, and/or a casino management system server 114. Gaming devices 104A-104X may include features to enable operation of any or all servers for use by the player and/or operator (e.g., the casino, resort, gaming establishment, tavern, pub, etc.). For example, game outcomes may be generated on a central determination gaming system server 106 and then transmitted over the network to any of a group of remote terminals or remote gaming devices 104A-104X that utilize the game outcomes and display the results to the players.

Gaming device 104A is often of a cabinet construction which may be aligned in rows or banks of similar devices for placement and operation on a casino floor. The gaming device 104A often includes a main door which provides access to the interior of the cabinet. Gaming device 104A typically includes a button area or button deck 120 accessible by a player that is configured with input switches or buttons 122, an access channel for a bill validator 124, and/or an access channel for a ticket-out printer 126.

In FIG. 1, gaming device 104A is shown as a Relm XL™ model gaming device manufactured by Aristocrat® Technologies, Inc. As shown, gaming device 104A is a reel machine having a gaming display area 118 comprising a number (typically 3 or 5) of mechanical reels 130 with various symbols displayed on them. The mechanical reels 130 are independently spun and stopped to show a set of symbols within the gaming display area 118 which may be used to determine an outcome to the game.

In many configurations, the gaming device 104A may have a main display 128 (e.g., video display monitor) mounted to, or above, the gaming display area 118. The main display 128 can be a high-resolution liquid crystal display (LCD), plasma, light emitting diode (LED), or organic light emitting diode (OLED) panel which may be flat or curved as shown, a cathode ray tube, or other conventional electronically controlled video monitor.

In some implementations, the bill validator 124 may also function as a “ticket-in” reader that allows the player to use a casino issued credit ticket to load credits onto the gaming device 104A (e.g., in a cashless ticket (“TITO”) system). In such cashless implementations, the gaming device 104A may also include a “ticket-out” printer 126 for outputting a credit ticket when a “cash out” button is pressed. Cashless TITO systems are used to generate and track unique bar-codes or other indicators printed on tickets to allow players to avoid the use of bills and coins by loading credits using a ticket reader and cashing out credits using a ticket-out printer 126 on the gaming device 104A. The gaming device 104A can have hardware meters for purposes including ensuring regulatory compliance and monitoring the player credit balance. In addition, there can be additional meters that record the total amount of money wagered on the gaming device, total amount of money deposited, total amount of money withdrawn, total amount of winnings on gaming device 104A.

In some implementations, a player tracking card reader 144, a transceiver for wireless communication with a mobile device (e.g., a player's smartphone), a keypad 146, and/or an illuminated display 148 for reading, receiving, entering, and/or displaying player tracking information is provided in gaming device 104A. In such implementations, a game controller within the gaming device 104A can communicate with the player tracking system server 110 to send and receive player tracking information.

Gaming device 104A may also include a bonus topper wheel 134. When bonus play is triggered (e.g., by a player achieving a particular outcome or set of outcomes in the primary game), bonus topper wheel 134 is operative to spin and stop with indicator arrow 136 indicating the outcome of the bonus game. Bonus topper wheel 134 is typically used to play a bonus game, but it could also be incorporated into play of the base or primary game.

A candle 138 may be mounted on the top of gaming device 104A and may be activated by a player (e.g., using a switch or one of buttons 122) to indicate to operations staff that gaming device 104A has experienced a malfunction or the player requires service. The candle 138 is also often used to indicate a jackpot has been won and to alert staff that a hand payout of an award may be needed.

There may also be one or more information panels 152 which may be a back-lit, silkscreened glass panel with lettering to indicate general game information including, for example, a game denomination (e.g., $0.25 or $1), pay lines, pay tables, and/or various game related graphics. In some implementations, the information panel(s) 152 may be implemented as an additional video display.

Gaming devices 104A have traditionally also included a handle 132 typically mounted to the side of main cabinet 116 which may be used to initiate game play.

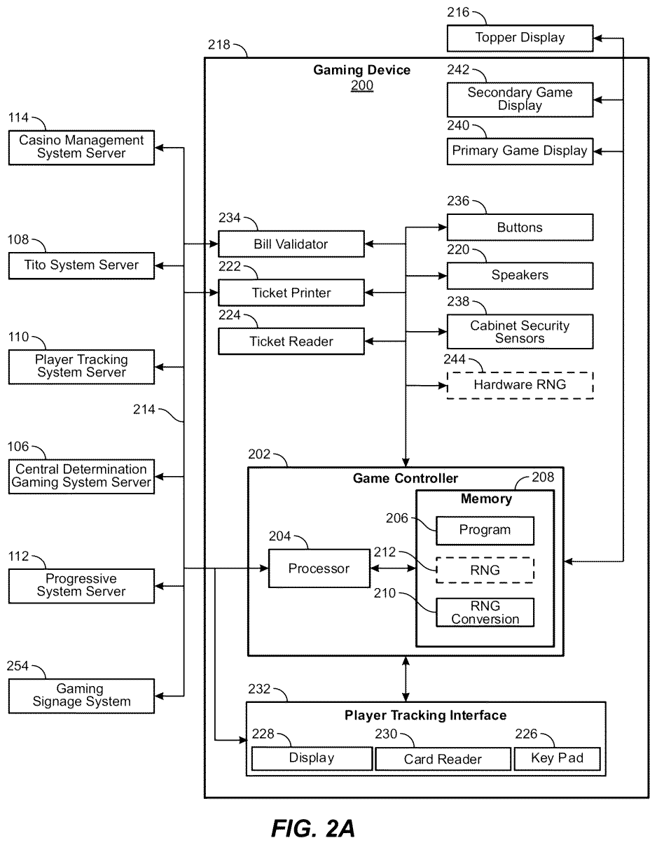

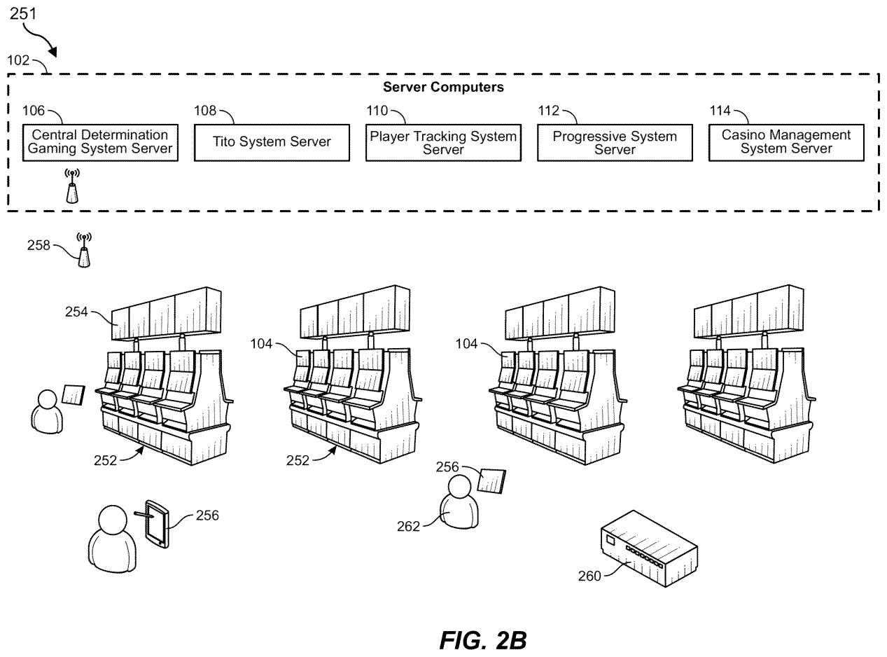

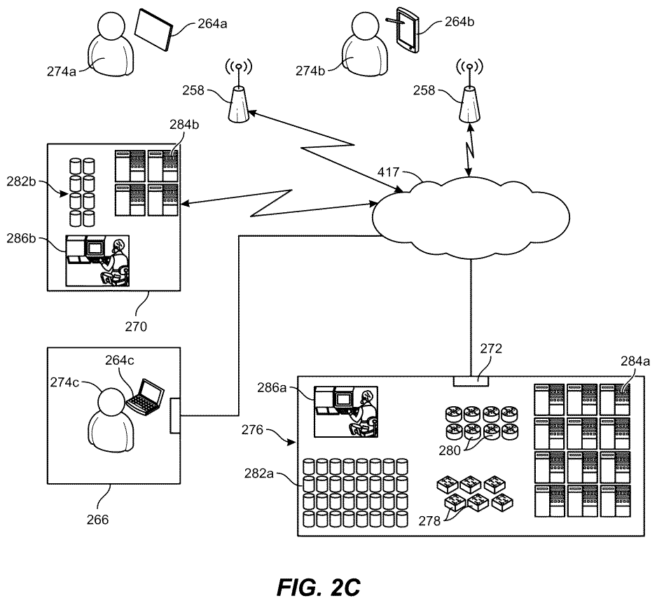

Many or all the above-described components can be controlled by circuitry (e.g., a game controller) housed inside the main cabinet 116 of the gaming device 104A, the details of which are shown in FIG. 2A.

An alternative example gaming device 104B illustrated in FIG. 1 is the Arc™ model gaming device manufactured by Aristocrat® Technologies, Inc. Note that where possible, reference numerals identifying similar features of the gaming device 104A implementation are also identified in the gaming device 104B implementation using the same reference numbers. Gaming device 104B does not include physical reels and instead shows game play functions on main display 128. An optional topper screen 140 may be used as a secondary game display for bonus play, to show game features or attraction activities while a game is not in play, or any other information or media desired by the game designer or operator. In some implementations, the optional topper screen 140 may also or alternatively be used to display progressive jackpot prizes available to a player during play of gaming device 104B.

Example gaming device 104B includes a main cabinet 116 including a main door which opens to provide access to the interior of the gaming device 104B. The main or service door is typically used by service personnel to refill the ticket-out printer 126 and collect bills and tickets inserted into the bill validator 124. The main or service door may also be accessed to reset the machine, verify and/or upgrade the software, and for general maintenance operations.

Another example gaming device 104C shown is the Helix™ model gaming device manufactured by Aristocrat® Technologies, Inc. Gaming device 104C includes a main display 128A that is in a landscape orientation. Although not illustrated by the front view provided, the main display 128A may have a curvature radius from top to bottom, or alternatively from side to side. In some implementations, main display 128A is a flat panel display. Main display 128A is typically used for primary game play while secondary display 128B is typically used for bonus game play, to show game features or attraction activities while the game is not in play or any other information or media desired by the game designer or operator. In some implementations, example gaming device 104C may also include speakers 142 to output various audio such as game sound, background music, etc.

Many different types of games, including mechanical slot games, video slot games, video poker, video black jack, video pachinko, keno, bingo, and lottery, may be provided with or implemented within the depicted gaming devices 104A-104C and other similar gaming devices. Each gaming device may also be operable to provide many different games. Games may be differentiated according to themes, sounds, graphics, type of game (e.g., slot game vs. card game vs. game with aspects of skill), denomination, number of paylines, maximum jackpot, progressive or non-progressive, bonus games, and may be deployed for operation in Class 2 or Class 3, etc.

FIG. 2A is a block diagram depicting example internal electronic components of a gaming device 200 connected to various external systems. All or parts of the gaming device 200 shown could be used to implement any one of the example gaming devices 104A-X depicted in FIG. 1. As shown in FIG. 2A, gaming device 200 includes a topper display 216 or another form of a top box (e.g., a topper wheel, a topper screen, etc.) that sits above cabinet 218. Cabinet 218 or topper display 216 may also house a number of other components which may be used to add features to a game being played on gaming device 200, including speakers 220, a ticket printer 222 which prints bar-coded tickets or other media or mechanisms for storing or indicating a player's credit value, a ticket reader 224 which reads bar-coded tickets or other media or mechanisms for storing or indicating a player's credit value, and a player tracking interface 232. Player tracking interface 232 may include a keypad 226 for entering information, a player tracking display 228 for displaying information (e.g., an illuminated or video display), a card reader 230 for receiving data and/or communicating information to and from media or a device such as a smart phone enabling player tracking. FIG. 2A also depicts utilizing a ticket printer 222 to print tickets for a TITO system server 108. Gaming device 200 may further include a bill validator 234, player-input buttons 236 for player input, cabinet security sensors 238 to detect unauthorized opening of the cabinet 218, a primary game display 240, and a secondary game display 242, each coupled to and operable under the control of game controller 202.

The games available for play on the gaming device 200 are controlled by a game controller 202 that includes one or more processors 204. Processor 204 represents a general-purpose processor, a specialized processor intended to perform certain functional tasks, or a combination thereof. As an example, processor 204 can be a central processing unit (CPU) that has one or more multi-core processing units and memory mediums (e.g., cache memory) that function as buffers and/or temporary storage for data. Alternatively, processor 204 can be a specialized processor, such as an application specific integrated circuit (ASIC), graphics processing unit (GPU), field-programmable gate array (FPGA), digital signal processor (DSP), or another type of hardware accelerator. In another example, processor 204 is a system on chip (SoC) that combines and integrates one or more general-purpose processors and/or one or more specialized processors. Although FIG. 2A illustrates that game controller 202 includes a single processor 204, game controller 202 is not limited to this representation and instead can include multiple processors 204 (e.g., two or more processors).

FIG. 2A illustrates that processor 204 is operatively coupled to memory 208. Memory 208 is defined herein as including volatile and nonvolatile memory and other types of non-transitory data storage components. Volatile memory is memory that do not retain data values upon loss of power. Nonvolatile memory is memory that do retain data upon a loss of power. Examples of memory 208 include random access memory (RAM), read-only memory (ROM), hard disk drives, solid-state drives, universal serial bus (USB) flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, examples of RAM include static random-access memory (SRAM), dynamic random access memory (DRAM), magnetic random access memory (MRAM), and other such devices. Examples of ROM include a programmable read-only memory (PROM), an erasable programmable read-only memory (EPROM), an electrically erasable programmable read-only memory (EEPROM), or other like memory device. Even though FIG. 2A illustrates that game controller 202 includes a single memory 208, game controller 202 could include multiple memories 208 for storing program instructions and/or data.

Memory 208 can store one or more game programs 206 that provide program instructions and/or data for carrying out various implementations (e.g., game mechanics) described herein. Stated another way, game program 206 represents an executable program stored in any portion or component of memory 208. In one or more implementations, game program 206 is embodied in the form of source code that includes human-readable statements written in a programming language or machine code that contains numerical instructions recognizable by a suitable execution system, such as a processor 204 in a game controller or other system. Examples of executable programs include: (1) a compiled program that can be translated into machine code in a format that can be loaded into a random access portion of memory 208 and run by processor 204; (2) source code that may be expressed in proper format such as object code that is capable of being loaded into a random access portion of memory 208 and executed by processor 204; and (3) source code that may be interpreted by another executable program to generate instructions in a random access portion of memory 208 to be executed by processor 204.

Alternatively, game programs 206 can be set up to generate one or more game instances based on instructions and/or data that gaming device 200 exchanges with one or more remote gaming devices, such as a central determination gaming system server 106 (not shown in FIG. 2A but shown in FIG. 1). For purpose of this disclosure, the term “game instance” refers to a play or a round of a game that gaming device 200 presents (e.g., via a user interface (UI)) to a player. The game instance is communicated to gaming device 200 via the network 214 and then displayed on gaming device 200. For example, gaming device 200 may execute game program 206 as video streaming software that allows the game to be displayed on gaming device 200. When a game is stored on gaming device 200, it may be loaded from memory 208 (e.g., from a read only memory (ROM)) or from the central determination gaming system server 106 to memory 208.

Gaming devices, such as gaming device 200, are highly regulated to ensure fairness and, in many cases, gaming device 200 is operable to award monetary awards (e.g., typically dispensed in the form of a redeemable voucher). Therefore, to satisfy security and regulatory requirements in a gaming environment, hardware and software architectures are implemented in gaming devices 200 that differ significantly from those of general-purpose computers. Adapting general purpose computers to function as gaming devices 200 is not simple or straightforward because of: (1) the regulatory requirements for gaming devices 200, (2) the harsh environment in which gaming devices 200 operate, (3) security requirements, (4) fault tolerance requirements, and (5) the requirement for additional special purpose componentry enabling functionality of an EGM. These differences require substantial engineering effort with respect to game design implementation, game mechanics, hardware components, and software.

One regulatory requirement for games running on gaming device 200 generally involves complying with a certain level of randomness. Typically, gaming jurisdictions mandate that gaming devices 200 satisfy a minimum level of randomness without specifying how a gaming device 200 should achieve this level of randomness. To comply, FIG. 2A illustrates that gaming device 200 could include an RNG 212 that utilizes hardware and/or software to generate RNG outcomes that lack any discernible pattern. The RNG operations are often specialized and non-generic in order to comply with regulatory and gaming requirements. For example, in a slot game, game program 206 can initiate multiple RNG calls to RNG 212 to generate RNG outcomes, where each RNG call and RNG outcome corresponds to an outcome for a reel. In another example, gaming device 200 can be a Class II gaming device where RNG 212 generates RNG outcomes for creating Bingo cards. In one or more implementations, RNG 212 could be one of a set of RNGs operating on gaming device 200. More generally, an output of the RNG 212 can be the basis on which game outcomes are determined by the game controller 202. Game developers could vary the degree of true randomness for each RNG (e.g., pseudorandom) and utilize specific RNGs depending on game requirements. The output of the RNG 212 can include a random or pseudorandom (either is generally referred to as a “random”) number. In some examples, the RNG 212 can be used to output random occurrences other than numbers, such as symbols, awards, number of awards, increments, events, etc.

Additionally, in some embodiments, weights may be applied to certain outcomes, such as to result in a predetermined distribution of outcomes over time. For example, first awards may have a high probability, second awards may have a medium probability, and third awards may have a low probability of occurring. The outcome of any given round or gameplay event may be random while substantially meeting the predetermined distribution of outcomes over many rounds.

In FIG. 2A, RNG 212 and hardware RNG 244 are shown in dashed lines to illustrate that RNG 212, hardware RNG 244, or both can be included in gaming device 200. In one implementation, instead of including RNG 212, gaming device 200 could include a hardware RNG 244 that generates RNG outcomes. Analogous to RNG 212, hardware RNG 244 performs specialized and non-generic operations in order to comply with regulatory and gaming requirements. For example, because of regulation requirements, hardware RNG 244 could be a random number generator that securely produces random numbers for cryptography use. The gaming device 200 then uses the secure random numbers to generate game outcomes for one or more game features. In another implementation, the gaming device 200 could include both hardware RNG 244 and RNG 212. RNG 212 may utilize the RNG outcomes from hardware RNG 244 as one of many sources of entropy for generating secure random numbers for the game features.

Another regulatory requirement for running games on gaming device 200 includes ensuring a certain level of RTP. Similar to the randomness requirement discussed above, numerous gaming jurisdictions also mandate that gaming device 200 provides a minimum level of RTP (e.g., RTP of at least 75%). A game can use one or more lookup tables (also called weighted tables) as part of a technical solution that satisfies regulatory requirements for randomness and RTP. In particular, a lookup table can integrate game features (e.g., trigger events for special modes or bonus games; newly introduced game elements such as extra reels, new symbols, or new cards; stop positions for dynamic game elements such as spinning reels, spinning wheels, or shifting reels; or card selections from a deck) with random numbers generated by one or more RNGs, so as to achieve a given level of volatility for a target level of RTP. (In general, volatility refers to the frequency or probability of an event such as a special mode, payout, etc. For example, for a target level of RTP, a higher-volatility game may have a lower payout most of the time with an occasional bonus having a very high payout, while a lower-volatility game has a steadier payout with more frequent bonuses of smaller amounts.) Configuring a lookup table can involve engineering decisions with respect to how RNG outcomes are mapped to game outcomes for a given game feature, while still satisfying regulatory requirements for RTP. Configuring a lookup table can also involve engineering decisions about whether different game features are combined in a given entry of the lookup table or split between different entries (for the respective game features), while still satisfying regulatory requirements for RTP and allowing for varying levels of game volatility.

FIG. 2A illustrates that gaming device 200 includes an RNG conversion engine 210 that translates the RNG outcome from RNG 212 to a game outcome presented to a player. To meet a designated RTP, a game developer can set up the RNG conversion engine 210 to utilize one or more lookup tables to translate the RNG outcome to a symbol element, stop position on a reel strip layout, and/or randomly chosen aspect of a game feature. As an example, the lookup tables can regulate a prize payout amount for each RNG outcome and how often the gaming device 200 pays out the prize payout amounts. The RNG conversion engine 210 could utilize one lookup table to map the RNG outcome to a game outcome displayed to a player and a second lookup table as a pay table for determining the prize payout amount for each game outcome. The mapping between the RNG outcome to the game outcome controls the frequency in hitting certain prize payout amounts.

FIG. 2A also depicts that gaming device 200 is connected over network 214 to player tracking system server 110. Player tracking system server 110 may be, for example, an OASIS® system manufactured by Aristocrat® Technologies, Inc. Player tracking system server 110 is used to track play (e.g. amount wagered, games played, time of play and/or other quantitative or qualitative measures) for individual players so that an operator may reward players in a loyalty program. The player may use the player tracking interface 232 to access his/her account information, activate free play, and/or request various information. Player tracking or loyalty programs seek to reward players for their play and help build brand loyalty to the gaming establishment. The rewards typically correspond to the player's level of patronage (e.g., to the player's playing frequency and/or total amount of game plays at a given casino). Player tracking rewards may be complimentary and/or discounted meals, lodging, entertainment and/or additional play. Player tracking information may be combined with other information that is now readily obtainable by a casino management system.

When a player wishes to play the gaming device 200, he/she can insert cash or a ticket voucher through a coin acceptor (not shown) or bill validator 234 to establish a credit balance on the gaming device. The credit balance is used by the player to place wagers on instances of the game and to receive credit awards based on the outcome of winning instances. The credit balance is decreased by the amount of each wager and increased upon a win. The player can add additional credits to the balance at any time. The player may also optionally insert a loyalty club card into the card reader 230. During the game, the player views with one or more UIs, the game outcome on one or more of the primary game display 240 and secondary game display 242. Other game and prize information may also be displayed.

For each game instance, a player may make selections, which may affect play of the game. For example, the player may vary the total amount wagered by selecting the amount bet per line and the number of lines played. In many games, the player is asked to initiate or select options during course of game play (such as spinning a wheel to begin a bonus round or select various items during a feature game). The player may make these selections using the player-input buttons 236, the primary game display 240 which may be a touch screen or using some other device which enables a player to input information into the gaming device 200.

During certain game events, the gaming device 200 may display visual and auditory effects that can be perceived by the player. These effects add to the excitement of a game, which makes a player more likely to enjoy the playing experience. Auditory effects include various sounds that are projected by the speakers 220. Visual effects include flashing lights, strobing lights or other patterns displayed from lights on the gaming device 200 or from lights behind the information panel 152 (FIG. 1).

When the player is done, he/she cashes out the credit balance (typically by pressing a cash out button to receive a ticket from the ticket printer 222). The ticket may be “cashed-in” for money or inserted into another machine to establish a credit balance for play.

Additionally, or alternatively, gaming devices 104A-104X and 200 can include or be coupled to one or more wireless transmitters, receivers, and/or transceivers (not shown in FIGS. 1 and 2A) that communicate (e.g., Bluetooth® or other near-field communication technology) with one or more mobile devices to perform a variety of wireless operations in a casino environment. Examples of wireless operations in a casino environment include detecting the presence of mobile devices, performing credit, points, comps, or other marketing or hard currency transfers, establishing wagering sessions, and/or providing a personalized casino-based experience using a mobile application. In one implementation, to perform these wireless operations, a wireless transmitter or transceiver initiates a secure wireless connection between a gaming device 104A-104X and 200 and a mobile device. After establishing a secure wireless connection between the gaming device 104A-104X and 200 and the mobile device, the wireless transmitter or transceiver does not send and/or receive application data to and/or from the mobile device. Rather, the mobile device communicates with gaming devices 104A-104X and 200 using another wireless connection (e.g., WiFi® or cellular network). In another implementation, a wireless transceiver establishes a secure connection to directly communicate with the mobile device. The mobile device and gaming device 104A-104X and 200 sends and receives data utilizing the wireless transceiver instead of utilizing an external network. For example, the mobile device would perform digital wallet transactions by directly communicating with the wireless transceiver. In one or more implementations, a wireless transmitter could broadcast data received by one or more mobile devices without establishing a pairing connection with the mobile devices.

Although FIGS. 1 and 2A illustrate specific implementations of a gaming device (e.g., gaming devices 104A-104X and 200), the disclosure is not limited to those implementations shown in FIGS. 1 and 2. For example, not all gaming devices suitable for implementing implementations of the present disclosure necessarily include top wheels, top boxes, information panels, cashless ticket systems, and/or player tracking systems. Further, some suitable gaming devices have only a single game display that includes only a mechanical set of reels and/or a video display, while others are designed for bar counters or tabletops and have displays that face upwards. Gaming devices 104A-104X and 200 may also include other processors that are not separately shown. Using FIG. 2A as an example, gaming device 200 could include display controllers (not shown in FIG. 2A) configured to receive video input signals or instructions to display images on game displays 240 and 242. Alternatively, such display controllers may be integrated into the game controller 202. The use and discussion of FIGS. 1 and 2 are examples to facilitate ease of description and explanation.

FIG. 2B depicts a casino gaming environment according to one example. In this example, the casino 251 includes banks 252 of EGMs 104. In this example, each bank 252 of EGMs 104 includes a corresponding gaming signage system 254 (also shown in FIG. 2A). According to this implementation, the casino 251 also includes mobile gaming devices 256, which are also configured to present wagering games in this example. The mobile gaming devices 256 may, for example, include tablet devices, cellular phones, smart phones and/or other handheld devices. In this example, the mobile gaming devices 256 are configured for communication with one or more other devices in the casino 251, including but not limited to one or more of the server computers 102, via wireless access points 258.

According to some examples, the mobile gaming devices 256 may be configured for stand-alone determination of game outcomes. However, in some alternative implementations the mobile gaming devices 256 may be configured to receive game outcomes from another device, such as the central determination gaming system server 106, one of the EGMs 104, etc.

Some mobile gaming devices 256 may be configured to accept monetary credits from a credit or debit card, via a wireless interface (e.g., via a wireless payment app), via tickets, via a patron casino account, etc. However, some mobile gaming devices 256 may not be configured to accept monetary credits via a credit or debit card. Some mobile gaming devices 256 may include a ticket reader and/or a ticket printer whereas some mobile gaming devices 256 may not, depending on the particular implementation.

In some implementations, the casino 251 may include one or more kiosks 260 that are configured to facilitate monetary transactions involving the mobile gaming devices 256, which may include cash out and/or cash in transactions. The kiosks 260 may be configured for wired and/or wireless communication with the mobile gaming devices 256. The kiosks 260 may be configured to accept monetary credits from casino patrons 262 and/or to dispense monetary credits to casino patrons 262 via cash, a credit or debit card, via a wireless interface (e.g., via a wireless payment app), via tickets, etc. According to some examples, the kiosks 260 may be configured to accept monetary credits from a casino patron and to provide a corresponding amount of monetary credits to a mobile gaming device 256 for wagering purposes, e.g., via a wireless link such as a near-field communications link. In some such examples, when a casino patron 262 is ready to cash out, the casino patron 262 may select a cash out option provided by a mobile gaming device 256, which may include a real button or a virtual button (e.g., a button provided via a graphical user interface) in some instances. In some such examples, the mobile gaming device 256 may send a “cash out” signal to a kiosk 260 via a wireless link in response to receiving a “cash out” indication from a casino patron. The kiosk 260 may provide monetary credits to the casino patron 262 corresponding to the “cash out” signal, which may be in the form of cash, a credit ticket, a credit transmitted to a financial account corresponding to the casino patron, etc.

In some implementations, a cash-in process and/or a cash-out process may be facilitated by the TITO system server 108. For example, the TITO system server 108 may control, or at least authorize, ticket-in and ticket-out transactions that involve a mobile gaming device 256 and/or a kiosk 260.

Some mobile gaming devices 256 may be configured for receiving and/or transmitting player loyalty information. For example, some mobile gaming devices 256 may be configured for wireless communication with the player tracking system server 110. Some mobile gaming devices 256 may be configured for receiving and/or transmitting player loyalty information via wireless communication with a patron's player loyalty card, a patron's smartphone, etc.

According to some implementations, a mobile gaming device 256 may be configured to provide safeguards that prevent the mobile gaming device 256 from being used by an unauthorized person. For example, some mobile gaming devices 256 may include one or more biometric sensors and may be configured to receive input via the biometric sensor(s) to verify the identity of an authorized patron. Some mobile gaming devices 256 may be configured to function only within a predetermined or configurable area, such as a casino gaming area.

FIG. 2C is a diagram that shows examples of components of a system for providing online gaming according to some aspects of the present disclosure. As with other figures presented in this disclosure, the numbers, types and arrangements of gaming devices shown in FIG. 2C are merely shown by way of example. In this example, various gaming devices, including but not limited to end user devices (EUDs) 264a, 264b and 264c are capable of communication via one or more networks 417. The networks 417 may, for example, include one or more cellular telephone networks, the Internet, etc. In this example, the EUDs 264a and 264b are mobile devices: according to this example the EUD 264a is a tablet device and the EUD 264b is a smart phone. In this implementation, the EUD 264c is a laptop computer that is located within a residence 266 at the time depicted in FIG. 2C. Accordingly, in this example the hardware of EUDs is not specifically configured for online gaming, although each EUD is configured with software for online gaming. For example, each EUD may be configured with a web browser. Other implementations may include other types of EUD, some of which may be specifically configured for online gaming.

In this example, a gaming data center 276 includes various devices that are configured to provide online wagering games via the networks 417. The gaming data center 276 is capable of communication with the networks 417 via the gateway 272. In this example, switches 278 and routers 280 are configured to provide network connectivity for devices of the gaming data center 276, including storage devices 282a, servers 284a and one or more workstations 270a. The servers 284a may, for example, be configured to provide access to a library of games for online game play. In some examples, code for executing at least some of the games may initially be stored on one or more of the storage devices 282a. The code may be subsequently loaded onto a server 284a after selection by a player via an EUD and communication of that selection from the EUD via the networks 417. The server 284a onto which code for the selected game has been loaded may provide the game according to selections made by a player and indicated via the player's EUD. In other examples, code for executing at least some of the games may initially be stored on one or more of the servers 284a. Although only one gaming data center 276 is shown in FIG. 2C, some implementations may include multiple gaming data centers 276.

In this example, a financial institution data center 270 is also configured for communication via the networks 417. Here, the financial institution data center 270 includes servers 284b, storage devices 282b, and one or more workstations 286a. According to this example, the financial institution data center 270 is configured to maintain financial accounts, such as checking accounts, savings accounts, loan accounts, etc. In some implementations one or more of the authorized users 274a-274c may maintain at least one financial account with the financial institution that is serviced via the financial institution data center 270.

According to some implementations, the gaming data center 276 may be configured to provide online wagering games in which money may be won or lost. According to some such implementations, one or more of the servers 284a may be configured to monitor player credit balances, which may be expressed in game credits, in currency units, or in any other appropriate manner. In some implementations, the server(s) 284a may be configured to obtain financial credits from and/or provide financial credits to one or more financial institutions, according to a player's “cash in” selections, wagering game results and a player's “cash out” instructions. According to some such implementations, the server(s) 284a may be configured to electronically credit or debit the account of a player that is maintained by a financial institution, e.g., an account that is maintained via the financial institution data center 270. The server(s) 284a may, in some examples, be configured to maintain an audit record of such transactions.

In some alternative implementations, the gaming data center 276 may be configured to provide online wagering games for which credits may not be exchanged for cash or the equivalent. In some such examples, players may purchase game credits for online game play, but may not “cash out” for monetary credit after a gaming session. Moreover, although the financial institution data center 270 and the gaming data center 276 include their own servers and storage devices in this example, in some examples the financial institution data center 270 and/or the gaming data center 276 may use offsite “cloud-based” servers and/or storage devices. In some alternative examples, the financial institution data center 270 and/or the gaming data center 276 may rely entirely on cloud-based servers.

One or more types of devices in the gaming data center 276 (or elsewhere) may be capable of executing middleware, e.g., for data management and/or device communication. Authentication information, player tracking information, etc., including but not limited to information obtained by EUDs 264 and/or other information regarding authorized users of EUDs 264 (including but not limited to the authorized users 274a-274c), may be stored on storage devices 282 and/or servers 284. Other game-related information and/or software, such as information and/or software relating to leaderboards, players currently playing a game, game themes, game-related promotions, game competitions, etc., also may be stored on storage devices 282 and/or servers 284. In some implementations, some such game-related software may be available as “apps” and may be downloadable (e.g., from the gaming data center 276) by authorized users.

In some examples, authorized users and/or entities (such as representatives of gaming regulatory authorities) may obtain gaming-related information via the gaming data center 276. One or more other devices (such EUDs 264 or devices of the gaming data center 276) may act as intermediaries for such data feeds. Such devices may, for example, be capable of applying data filtering algorithms, executing data summary and/or analysis software, etc. In some implementations, data filtering, summary and/or analysis software may be available as “apps” and downloadable by authorized users.

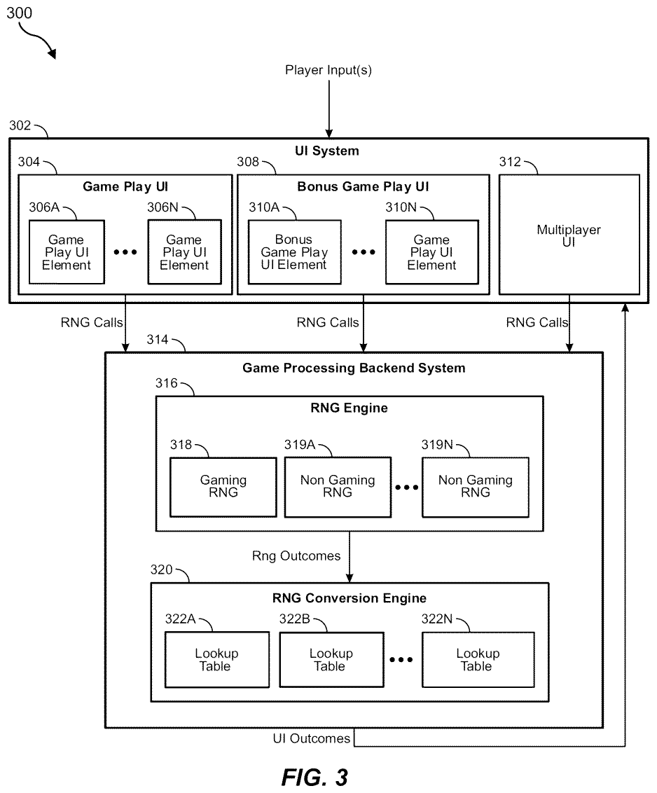

FIG. 3 illustrates, in block diagram form, an implementation of a game processing architecture 300 that implements a game processing pipeline for the play of a game in accordance with various implementations described herein. As shown in FIG. 3, the gaming processing pipeline starts with having a UI system 302 receive one or more player inputs for the game instance. Based on the player input(s), the UI system 302 generates and sends one or more RNG calls to a game processing backend system 314. Game processing backend system 314 then processes the RNG calls with RNG engine 316 to generate one or more RNG outcomes. The RNG outcomes are then sent to the RNG conversion engine 320 to generate one or more game outcomes for the UI system 302 to display to a player. The game processing architecture 300 can implement the game processing pipeline using a gaming device, such as gaming devices 104A-104X and 200 shown in FIGS. 1 and 2, respectively. Alternatively, portions of the gaming processing architecture 300 can implement the game processing pipeline using a gaming device and one or more remote gaming devices, such as central determination gaming system server 106 shown in FIG. 1.

The UI system 302 includes one or more UIs that a player can interact with. The UI system 302 could include one or more game play UIs 304, one or more bonus game play UIs 308, and one or more multiplayer UIs 312, where each UI type includes one or more mechanical UIs and/or graphical UIs (GUIs). In other words, game play UI 304, bonus game play UI 308, and the multiplayer UI 312 may utilize a variety of UI elements, such as mechanical UI elements (e.g., physical “spin” button or mechanical reels) and/or GUI elements (e.g., virtual reels shown on a video display or a virtual button deck) to receive player inputs and/or present game play to a player. Using FIG. 3 as an example, the different UI elements are shown as game play UI elements 306A-306N and bonus game play UI elements 310A-310N.

The game play UI 304 represents a UI that a player typically interfaces with for a base game. During a game instance of a base game, the game play UI elements 306A-306N (e.g., GUI elements depicting one or more virtual reels) are shown and/or made available to a user. In a subsequent game instance, the UI system 302 could transition out of the base game to one or more bonus games. The bonus game play UI 308 represents a UI that utilizes bonus game play UI elements 310A-310N for a player to interact with and/or view during a bonus game. In one or more implementations, at least some of the game play UI element 306A-306N are similar to the bonus game play UI elements 310A-310N. In other implementations, the game play UI element 306A-306N can differ from the bonus game play UI elements 310A-310N.

FIG. 3 also illustrates that UI system 302 could include a multiplayer UI 312 purposed for game play that differs or is separate from the typical base game. For example, multiplayer UI 312 could be set up to receive player inputs and/or presents game play information relating to a tournament mode. When a gaming device transitions from a primary game mode that presents the base game to a tournament mode, a single gaming device is linked and synchronized to other gaming devices to generate a tournament outcome. For example, multiple RNG engines 316 corresponding to each gaming device could be collectively linked to determine a tournament outcome. To enhance a player's gaming experience, tournament mode can modify and synchronize sound, music, reel spin speed, and/or other operations of the gaming devices according to the tournament game play. After tournament game play ends, operators can switch back the gaming device from tournament mode to a primary game mode to present the base game. Although FIG. 3 does not explicitly depict that multiplayer UI 312 includes UI elements, multiplayer UI 312 could also include one or more multiplayer UI elements.

Based on the player inputs, the UI system 302 could generate RNG calls to a game processing backend system 314. As an example, the UI system 302 could use one or more application programming interfaces (APIs) to generate the RNG calls. To process the RNG calls, the RNG engine 316 could utilize gaming RNG 318 and/or non-gaming RNGs 319A-319N. Gaming RNG 318 could corresponds to RNG 212 or hardware RNG 244 shown in FIG. 2A. As previously discussed with reference to FIG. 2A, gaming RNG 318 often performs specialized and non-generic operations that comply with regulatory and/or game requirements. For example, because of regulation requirements, gaming RNG 318 could correspond to RNG 212 by being a cryptographic RNG or pseudorandom number generator (PRNG) (e.g., Fortuna PRNG) that securely produces random numbers for one or more game features. To securely generate random numbers, gaming RNG 318 could collect random data from various sources of entropy, such as from an operating system (OS) and/or a hardware RNG (e.g., hardware RNG 244 shown in FIG. 2A). Alternatively, non-gaming RNGs 319A-319N may not be cryptographically secure and/or be computationally less expensive. Non-gaming RNGs 319A-319N can, thus, be used to generate outcomes for non-gaming purposes. As an example, non-gaming RNGs 319A-319N can generate random numbers for generating random messages that appear on the gaming device.

The RNG conversion engine 320 processes each RNG outcome from RNG engine 316 and converts the RNG outcome to a UI outcome that is feedback to the UI system 302. With reference to FIG. 2A, RNG conversion engine 320 corresponds to RNG conversion engine 210 used for game play. As previously described, RNG conversion engine 320 translates the RNG outcome from the RNG 212 to a game outcome presented to a player. RNG conversion engine 320 utilizes one or more lookup tables 322A-322N to regulate a prize payout amount for each RNG outcome and how often the gaming device pays out the derived prize payout amounts. In one example, the RNG conversion engine 320 could utilize one lookup table to map the RNG outcome to a game outcome displayed to a player and a second lookup table as a pay table for determining the prize payout amount for each game outcome. In this example, the mapping between the RNG outcome and the game outcome controls the frequency in hitting certain prize payout amounts. Different lookup tables could be utilized depending on the different game modes, for example, a base game versus a bonus game.

After generating the UI outcome, the game processing backend system 314 sends the UI outcome to the UI system 302. Examples of UI outcomes are symbols to display on a video reel or reel stops for a mechanical reel. In one example, if the UI outcome is for a base game, the UI system 302 updates one or more game play UI elements 306A-306N, such as symbols, for the game play UI 304. In another example, if the UI outcome is for a bonus game, the UI system could update one or more bonus game play UI elements 310A-310N (e.g., symbols) for the bonus game play UI 308. In response to updating the appropriate UI, the player may subsequently provide additional player inputs to initiate a subsequent game instance that progresses through the game processing pipeline.

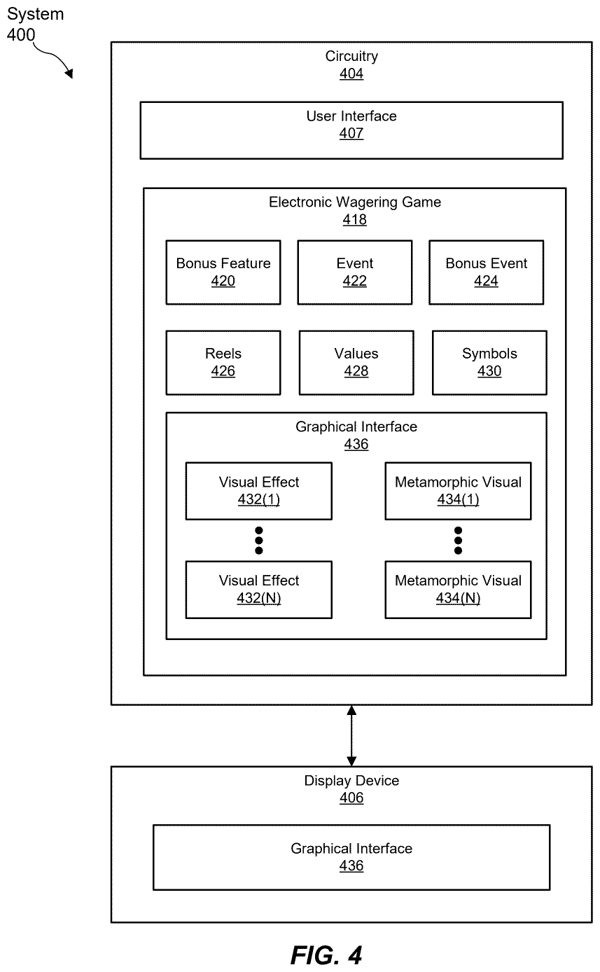

FIG. 4 illustrates an example system 400 for displaying visual effects corresponding to events that occur in connection with bonus features of electronic wagering games. As illustrated in FIG. 4, system 400 may include and/or represent circuitry 404 and a display device 406. In some examples, circuitry 404 may implement and/or execute an electronic wagering game 418 in conjunction with display device 416. In one example, circuitry 404 may include and/or represent a user interface 407 that enables a user to enter and/or provide input in connection with electronic wagering game 418. In this example, circuitry 404 may direct and/or cause display device 406 to render and/or present a graphical interface 436 of electronic wagering game 418 for viewing by the user.

In some examples, electronic wagering game 418 may include and/or represent reels 426 configured to spin in connection with wagers made by the user. In one example, reels 426 may include and/or represent symbols 430 that spin, rotate, and/or change during gameplay. In this example, certain combinations and/or sequences of symbols 430 across reels 426 may constitute a win and/or increase for the user. As a result, the electronic wagering game 418 may award and/or grant, to the user, a certain monetary value and/or credit associated with one or more of symbols 430 and/or their corresponding combinations or sequences.

In some examples, graphical interface 436 of electronic wagering game 418 may include and/or represent one or more metamorphic visuals 434(1)-(N). In one example, metamorphic visuals 434(1)-(N) may include and/or represent graphical objects that represent certain features and/or attributes of the gameplay, such as values and/or credits accumulated by one or more users, progress toward achieving a bonus game and/or game modifier, increments on progressives, durations and/or amounts of time since the last time a certain bonus was awarded, etc. In this example, metamorphic visuals 434(1)-(N) may include and/or represent perceived-persistence graphics, pseudo-persistence graphics, and/or true-persistence graphics.

In some examples of the metamorphic visuals 434(1)-(N), circuitry 404 may detect, recognize, and/or identify an event 422 that triggers incrementing a bonus feature trigger meter that represents the apparent progress toward unlocking a bonus feature 420 of the electronic wagering game 418 in connection with one or more of metamorphic visuals 434(1)-(N). In one example, event 422 may include and/or represent a random occurrence, a performance-driven occurrence, a wager-driven occurrence, and/or a time-driven occurrence. For example, event 422 may occur as a result of random number generation. Additionally or alternatively, event 422 may occur as a result of a certain amount of time having elapsed since a previous bonus feature 420 was achieved by electronic wagering game 418.

In one example, the bonus feature trigger meter may include and/or represent a counter that tracks and/or corresponds to the number of increments that were previously attained by electronic wagering game 418 since the bonus feature 420 was last achieved. In certain implementations, circuitry 404 may detect event 422 by determining that one or more certain symbols 430 or combinations thereof have been displayed on reels 426 after a user has initiated gameplay of a game or round. For example, circuitry 404 may cause a random group of symbols from symbols 430 to be displayed on reels 426 on display device 406. If one or more of these displayed symbols 430, or a combination of certain symbols 430, constitutes an event 422 that triggers incrementing the bonus feature trigger meter, one or more of metamorphic visuals 434(1)-(N) may be incremented. In some examples, event 422 may cause circuitry 404 (e.g., an RNG of circuitry 404) to determine a random number of steps between zero steps and one less than all remaining steps to fill the bonus feature trigger meter. The determined random number of steps may be weighted, such that there may be, for example, an increased likelihood of a lower number of steps compared to a higher number of steps. -

In some examples, circuitry 404 may implement and/or execute bonus feature 420 of electronic wagering game 418 in response to event 422. In one example, bonus feature 420 may include and/or represent a free game awarded and/or granted to the user during gameplay. In this example, the free game may include and/or represent a game mechanic in which the user does not wager additional credits to play. By way of example, in connection with the bonus feature 420, the user may first be presented at least one bonus wheel including enhancement symbols from which an enhancement is to be randomly selected by circuitry 404, such as in response to initiation by the user. In this example, bonus feature 420 may next include spinning bonus reels that provide a chance for the user to win additional credits or other prizes. The bonus reels may be enhanced by the selected enhancement attained from the bonus wheel. For example, the bonus wheel may present enhancement symbols for enhancements such as: advancement toward improved chances for higher payouts in connection with the bonus reels, one or more additional rows of bonus symbols in the bonus reels, and/or one or more additional rounds to play the bonus reels. Circuitry 404 may later terminate the bonus feature 420 upon determining that the user has completed all the spins allotted to the user, and the circuitry 404 may cause the display device 406 to again display the base game for playing by the user.

In some examples, bonus feature 420 may include more than one bonus wheel for providing one or more bonus game enhancements. For example, a first bonus wheel may be configured to present first enhancement symbols to be randomly selected when the first bonus wheel is activated, a second bonus wheel may be configured to present second enhancement symbols to be randomly selected when the second bonus wheel is activated, and a third bonus wheel may be configured to present third enhancement symbols to be randomly selected when the third bonus wheel is activated. In some examples, the first enhancement symbols, second enhancement symbols, and third enhancement symbols may represent enhancements for the bonus game that are different from each other. For example, one of the bonus wheels may be for enhancing the bonus game with advancement toward improved chances for higher payouts in connection with the bonus reels, another bonus wheel may be for enhancing the bonus game with one or more additional rows of bonus symbols in the bonus reels, and the last bonus wheel may be for enhancing the bonus wheel with one or more additional rounds to play the bonus reels.

In some examples, more than one bonus wheel and corresponding enhancements may be triggered by event 422. For example, a first bonus feature trigger meter corresponding to the first bonus wheel and a second bonus feature trigger meter corresponding to the second bonus wheel may both be filled in a same round of gameplay. For example, event 422 may include the landing of two symbols that respectively trigger incrementing the first bonus feature trigger meter until full and incrementing the second bonus feature trigger meter until full. In this case, both the first bonus wheel and corresponding first enhancement and the second bonus wheel and corresponding second enhancement may be triggered for a single session of bonus feature 420.

Additionally or alternatively, in some embodiments of bonus feature 420, among the first enhancement symbols, the first bonus wheel may include a second bonus wheel symbol that can be randomly selected to trigger another spin of the first bonus wheel (for selection of another first enhancement) and a spin of the second bonus wheel. Likewise, the first enhancement symbols may include a third bonus wheel symbol that can be randomly selected to trigger another spin of the first bonus wheel (for selection of another first enhancement) and a spin of the third bonus wheel. Similarly, the second bonus wheel may include a first bonus wheel symbol and a third bonus wheel symbol among the second enhancement symbols and the third bonus wheel may include a first bonus wheel symbol and a second bonus wheel symbol among the third enhancement symbols. Accordingly, a player may, in some instances, have a chance to achieve a first enhancement, a second enhancement, and/or a third enhancement for enhancing a session of the bonus game. For example, depending on the outcome of the first bonus wheel, second bonus wheel, and/or third bonus wheel, a session of the bonus game may be enhanced with one, two, or three of the following enhancements: advancement toward improved chances for higher payouts in connection with the bonus reels, one or more additional rows of bonus symbols in the bonus reels, and/or one or more additional rounds to play the bonus reels.

In some examples, during the implementation of bonus feature 420, circuitry 404 may detect, recognize, and/or identify a bonus event 424 that triggers and/or activates a first collection of one or more values 428 represented by one or more symbols that land on reels 426. For example, circuitry 404 may detect an event that triggers and/or activates an award all the COR symbols that appear on reels 426. In one example, bonus event 424 may include and/or represent a random occurrence, a performance-driven occurrence, a wager-driven occurrence, and/or a time-driven occurrence. For example, bonus event 424 may occur as a result of random number generation, such as by an RNG of circuitry 404. Additionally or alternatively, bonus event 424 may occur as a result of a certain amount of time having elapsed since a previous collection was performed or since the start of bonus feature 420.

In some examples, circuitry 404 may terminate and/or end bonus feature 420 once the user has completed all the spins allotted to the user in connection with bonus feature 420. In one example, upon completion of bonus feature 420, circuitry 404 may implement and/or perform a second collection of one or more values represented by the COR symbols that landed on bonus reels during bonus feature 420. In other words, circuitry 404 may implement and/or perform this second collection in response to the completion of bonus feature 420. In certain implementations, because all the COR symbols whose values were attributed to the user in the first collection are held over until the second collection, circuitry 404 may attribute those values to the user again as part of the second collection. Accordingly, the second collection may involve reattributing all the values from the first collection to the user as well as attributing the values of any COR symbols that subsequently landed on reels 426 after the first collection.

In some examples, circuitry 404 may direct and/or cause display device 406 to render and/or present one or more visual effects 432(1)-(N) corresponding to event 422 and/or bonus event 424. For example, circuitry 404 may direct and/or cause display device 406 to animate one or more of metamorphic visuals 434(1)-(N) in graphical interface 436 to indicate that bonus feature 420 has been awarded to the user. Additionally or alternatively, circuitry 404 may direct and/or cause display device 406 to animate one or more of metamorphic visuals 434(1)-(N) in graphical interface 436 to indicate that the first collection has been awarded to and/or performed for the user. Such animations may communicate and/or convey, to the user, that event 422 and/or bonus event 424 has occurred. Additionally or alternatively, circuitry 404 may direct and/or cause display device 406 to animate one or more of metamorphic visuals 434(1)-(N) in graphical interface 436 to indicate that the second collection has been awarded to and/or performed for the user.

In some examples, circuitry 404 may include and/or represent one or more electrical and/or electronic circuits capable of processing, applying, modifying, transforming, displaying, transmitting, receiving, and/or executing data for system 400. Circuitry 404 may be communicatively and/or electrically coupled to display device 406. In one example, circuitry 404 may access and/or analyze data stored in memory to facilitate and/or support activating and/or displaying visual effects 432(1)-(N) corresponding to events in connection with bonus feature 420. Additionally or alternatively, circuitry 404 may launch, perform, and/or execute certain executable files, code snippets, and/or computer-readable instructions to facilitate and/or support activating and/or displaying visual effects 432(1)-(N) corresponding to events in connection with bonus feature 420. In certain implementations, circuitry 404 may provide display device 406 with instructions and/or commands that, upon execution, cause display device 406 to present and/or modify graphical interface 436 in accordance with the progression of electronic wagering game 418.

Although illustrated as a single unit in FIG. 4, circuitry 404 may include and/or represent a collection of multiple processing units and/or electrical or electronic components that work and/or operate in conjunction with one another. In one example, circuitry 404 may include and/or represent a central processing unit (CPU) and/or a graphics processing unit (GPU). In another example, circuitry 404 may include and/or represent an application-specific integrated circuit (ASIC). In certain implementations, circuitry 404 may be included and/or incorporated in an EGM. Additionally or alternatively, circuitry 404 may be included and/or incorporated in a server and/or one or more client devices of system 400. Examples of circuitry 404 include, without limitation, processing devices, microprocessors, microcontrollers, GPUs, CPUs, ASICs, field-programmable gate arrays (FPGAs), systems on chips (SoCs), parallel accelerated processors, tensor cores, integrated circuits, chiplets, optical modules, receivers, transmitters, transceivers, storage devices, memory devices, logical circuitry, portions of one or more of the same, variations or combinations of one or more of the same, and/or any other suitable circuitry.

In some examples, the various devices, components, and/or features described in connection with FIG. 4 may include and/or represent one or more additional circuits, components, and/or features that are not necessarily illustrated and/or labeled in FIG. 4. For example, the systems, components, and/or features illustrated in FIG. 4 may also include and/or represent additional analog and/or digital circuitry, onboard logic, transistors, RF transmitters, RF receivers, transceivers, antennas, resistors, capacitors, diodes, inductors, switches, registers, flipflops, digital logic, connections, traces, buses, semiconductor (e.g., silicon) devices and/or structures, processing devices, storage devices, memory devices, circuit boards, sensors, packages, substrates, housings, servers, client devices, computing devices, combinations or variations of one or more of the same, and/or any other suitable components. In certain implementations, one or more of these additional circuits, components, and/or features may be inserted and/or applied between any of the existing circuits, components, and/or features illustrated in FIG. 4 consistent with the aims and/or objectives described herein. Accordingly, the couplings and/or connections described with reference to FIG. 4 may be direct connections with no intermediate components, devices, and/or nodes or indirect connections with one or more intermediate components, devices, and/or nodes.

In some examples, the phrase “to couple” and/or the term “coupling,” as used herein, may refer to a direct connection and/or an indirect connection. For example, a direct coupling between two components may constitute and/or represent a coupling in which those two components are directly connected to each other by a single node that provides continuity from one of those two components to the other. In other words, the direct coupling may exclude and/or omit any additional components between those two components. Additionally or alternatively, an indirect coupling between two components may constitute and/or represent a coupling in which those two components are indirectly connected to each other by multiple nodes that fail to provide continuity from one of those two components to the other. In other words, the indirect coupling may include and/or incorporate at least one additional component between those two components.

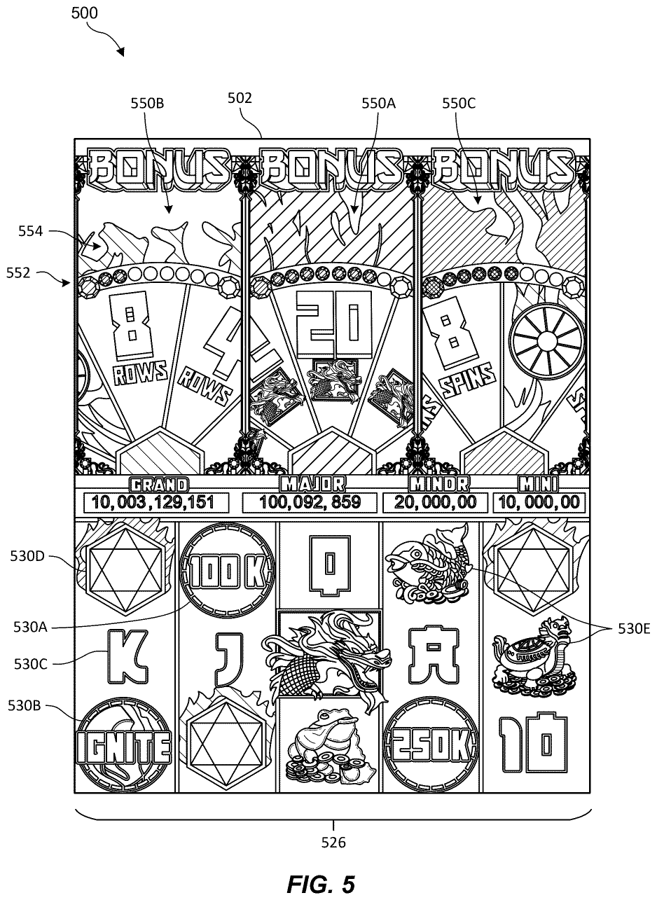

FIGS. 5-10 illustrate an example implementation of a graphical interface 500 presented via a display device 502. Graphical interface 500 may be implemented as or in place of graphical interface 436 described above. In some examples, graphical interface 500 may include and/or represent certain elements, components, and/or features that perform and/or provide functionalities that are similar and/or identical to those described above in connection with any of FIGS. 1-4.

As illustrated in FIG. 5, graphical interface 500 may include and/or represent a base game involving symbols 530 on reels 526 and/or metamorphic visuals in the form of a first bonus feature trigger meter 550A, a second bonus feature trigger meter 550B, and a third bonus feature trigger meter 550C, collectively referred to herein as bonus feature trigger meters 550.

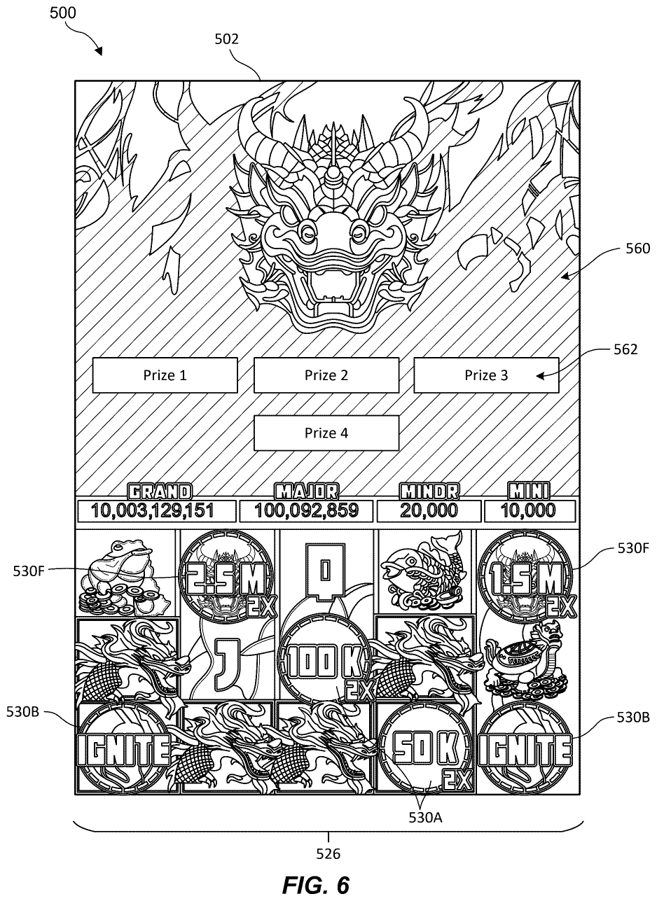

In some examples, the base game may involve spinning reels 526 and determining which symbols 530 are landed on reels 526. Depending on symbols 530 that are landed, various results may be achieved. For example, COR symbols 530A may display points and/or credits to be awarded to the user when an ignite symbol 530B is landed together with one or more COR symbols 530A. If more than one ignite symbol 530B is simultaneously landed, then more than one corresponding award of each displayed COR symbol 530A may be granted. Enhanced COR symbols (e.g., super COR symbols 530F) may also be included on reels 526. An example of super COR symbols 530F and associated gameplay are described below with reference to FIG. 6.

Referring again to FIG. 5, in some examples, reels 526 may include royal symbols 530C (e.g., represented by 10, J, Q, K, A in FIG. 5) that may result in an award if one or more predetermined combinations and/or arrangements thereof are landed on reels 526.

In some examples, bonus feature trigger meters 550 may include and/or represent the apparent progress of a user toward unlocking a bonus feature (e.g., bonus feature 420). In one example, circuitry 404 may detect and/or monitor bonus feature trigger meters 550. Additionally or alternatively, circuitry 404 may direct display device 502 to modify bonus feature trigger meters 550. In this example, bonus feature trigger meters 550 may represent increments and/or steps toward unlocking the bonus feature, including a bonus game and a bonus wheel for enhancements of the bonus game.

By way of example, bonus feature trigger meters 550 are represented in FIG. 5 as a number of gems 552 that can be highlighted as progress toward filling the bonus feature trigger meters 550 is achieved. In the example shown in FIG. 5, each of the bonus feature trigger meters 550 includes a series of ten gems 552, which may be distinguished by different colors and/or patterns. First bonus feature trigger meter 550A shows eight of the ten gems 552 highlighted, with two remaining before triggering the bonus feature with a first enhancement associated with the first bonus feature trigger meter 550A (e.g., improved chances for higher payouts in a bonus game). Second bonus feature trigger meter 550B shows three of the ten gems 552 highlighted, with seven remaining before triggering the bonus feature with a second enhancement associated with the second bonus feature trigger meter 550B (e.g., additional rows of symbols during the bonus game). Third bonus feature trigger meter 550C shows six of the ten gems 552 highlighted, with four remaining before triggering the bonus feature with a third enhancement associated with the third bonus feature trigger meter 550C (e.g., additional spins of reels during the bonus game). Alternatively or additionally, the bonus feature trigger meters 550 may include flames 554 or other visuals that grow in size, quantity, and/or intensity as the bonus feature trigger meters 550 are incremented toward being filled.

In some examples, reels 526 may include bonus trigger symbols 530D (e.g., represented by gems in FIG. 5) that may increment respective bonus feature trigger meters 550 when landed on reels 526. In some embodiments, each bonus trigger symbol 530D that is landed may increment the respective bonus feature trigger meter 550 by a random number of steps between zero steps and one less than all remaining steps to fill the respective bonus feature trigger meter 550. For example, an RNG may be used to determine, such as using a weight table, the random number of steps to increment the respective bonus feature trigger meter 550 each time a bonus trigger symbol 530D is landed. In the example shown in FIG. 5, third bonus feature trigger meter 550C has six gems 552 highlighted, with four gems remaining before the third bonus feature trigger meter 550C is filled. When a bonus trigger symbol 530D associated with third bonus feature trigger meter 550C lands on reels 526, circuitry 404 may determine a random number of gems 552 to highlight between zero gems 552 and one less than all four remaining gems 552. In some embodiments, the number of gems 552 to highlight may be weighted, such as a lower number of gems 552 having a higher probability than a higher number of gems 552. In additional examples, an RNG of circuitry 404 may determine, such as using another weight table, when all remaining gems 552 may be added to fill at least one of bonus feature trigger meters 550 to capacity.

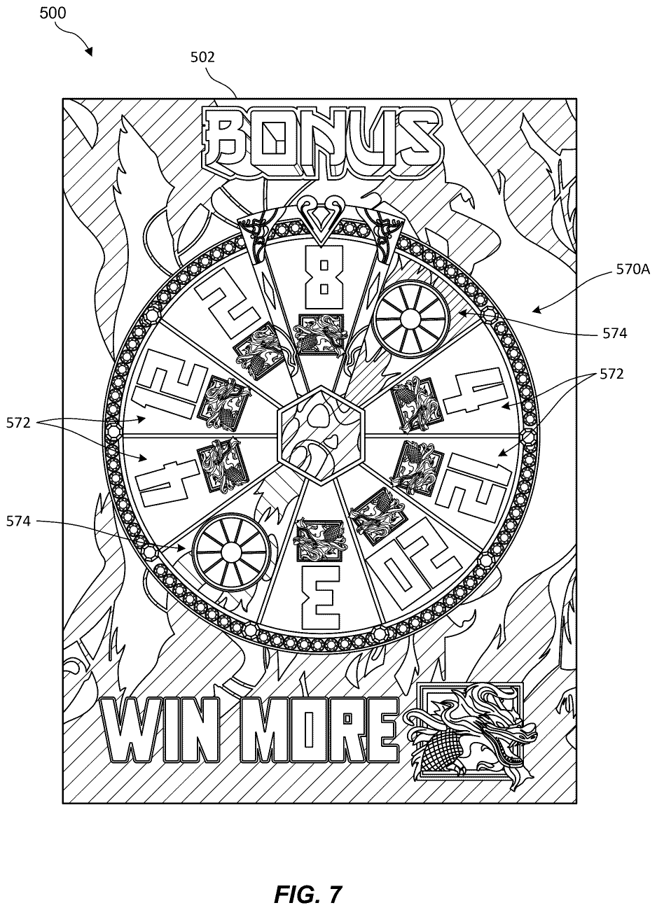

When one or more of bonus feature trigger meters 550 is filled, a bonus feature (e.g., bonus wheel(s) and/or a bonus game with enhancement(s) from bonus wheel(s)) may be displayed on display device 502. An example implementation of the bonus feature is further described below with reference to FIGS. 7-10.

In some examples, additional symbols 530, such as placeholder symbols 530E, may also be presented on reels 526. Placeholder symbols 530E may not correspond to any award, or may result in an award if one or more predetermined combinations and/or arrangements thereof are landed on reels 526.

In some examples, events and/or actions performed during gameplay may result from and/or be caused by one or more interactions (such as wagers) between the user and/or an electronic wagering game incorporating the graphical interface 500. Additionally or alternatively, circuitry 404 may direct display device 502 to modify reels 526, symbols 530 on reels 526, bonus feature trigger meters 550, and/or animations, etc., based on events and/or actions performed by user and/or by circuitry 404.

In some examples, as illustrated in FIG. 6, in connection with the base game and at least in part in connection with random number generation, circuitry 404 may cause the display device 502 to display reels 526 with one or more COR symbols 530A and/or one or more super COR symbols 530F in combination with one or more ignite symbols 530B. In the example shown in FIG. 6, reels 526 have been played to land two COR symbols 530A, two super COR symbols 530F, and two ignite symbols 530B. An award associated with each of COR symbols 530A may be paid out twice due to the landing of the two ignite symbols 530B. In some embodiments an award associated with each of the super COR symbols 530F may be paid out twice.

Additionally or alternatively, the landing of each of the super COR symbols 530F may result in a super COR feature 560, which may result in awarding a number of prizes 562. In some examples, the number of prizes 562 may be a random number between a predetermined minimum and maximum number of prizes 562. By way of example and not limitation, super COR feature 560 may award between one prize 562 and one hundred prizes 562, such as between two prizes 562 and fifty prizes 562, between five prizes 562 and fifty prizes 562, between ten prizes 562 and one hundred prizes 562, etc. In the example of FIG. 6, four prizes 562 are shown as being awarded. Each of the prizes 562 may be the same as or different from each other. In some examples, each of the prizes 562 may be a randomly determined prize and/or amount. For example, an RNG of circuitry 404 may be used to determine the number of prizes 562 and/or the amount of each prize 562.

After the super COR feature 506 is completed and prizes 562 are awarded, the base game (e.g., as shown in FIG. 5) may again be displayed on display device 502.

During implementation of the base game, any of bonus feature trigger meters 550 may become filled, such as in response to one or more bonus trigger symbols 530D landing on reels 526 and a random number of steps being selected by circuitry 404 to increment at least one of bonus feature trigger meters 550 to a filled state. When at least one of the bonus feature trigger meters 550 is filled, a bonus feature may be activated by circuitry 404 and displayed on display device 502. FIG. 7-9 illustrate three example bonus wheels 570A, 570B, and 570C (collectively referred to as bonus wheels 570) associated with the respective bonus feature trigger meters 550A, 550B, and 550C.

Referring to FIG. 7, a first bonus wheel 570A activated in response to filling a first one of bonus feature trigger meters 550A is illustrated. The first bonus wheel 570A includes first enhancement symbols 572 and additional bonus wheel symbols 574. First enhancement symbols 572 may represent emblems for advancement toward improved chances for higher payouts in a bonus game. By way of example, the first enhancement symbols 572 are illustrated as dragon head emblems and an associated quantity in FIG. 7. An increased number of first enhancement symbols 572 that are collected from the first bonus wheel 570A and/or during the bonus game may improve a chance of a higher payout in the bonus game, such as when a super COR feature 506 is achieved in the bonus game. Circuitry 404 (e.g., an RNG of circuitry 404) may randomly select which of first enhancement symbols 572 and, optionally, additional bonus wheel symbols 574 are landed during implementation of the bonus feature.

The additional bonus wheel symbols 574 may represent second bonus wheel 570B and third bonus wheel 570C. Landing on one of the additional bonus wheel symbols 574 may result in an additional spin of the first bonus wheel 570A to achieve a first enhancement for the bonus game as well as presentation of a respective one of second bonus wheel 570B or third bonus wheel 570C for selecting an additional enhancement for the bonus game. Accordingly, in some embodiments, two or more of bonus wheels 570A-570C may be attained and corresponding enhancements applied to the bonus game in a variety of ways. One way of attaining two or more of bonus wheels 570A-570C may be simultaneously filling the respective bonus feature trigger meters 550 during implementation of the base game. Another way of attaining two or more of bonus wheels 570A-570C may be through landing on one or more of additional bonus wheel symbols 574 during implementation of one of bonus wheels 570A-570C.

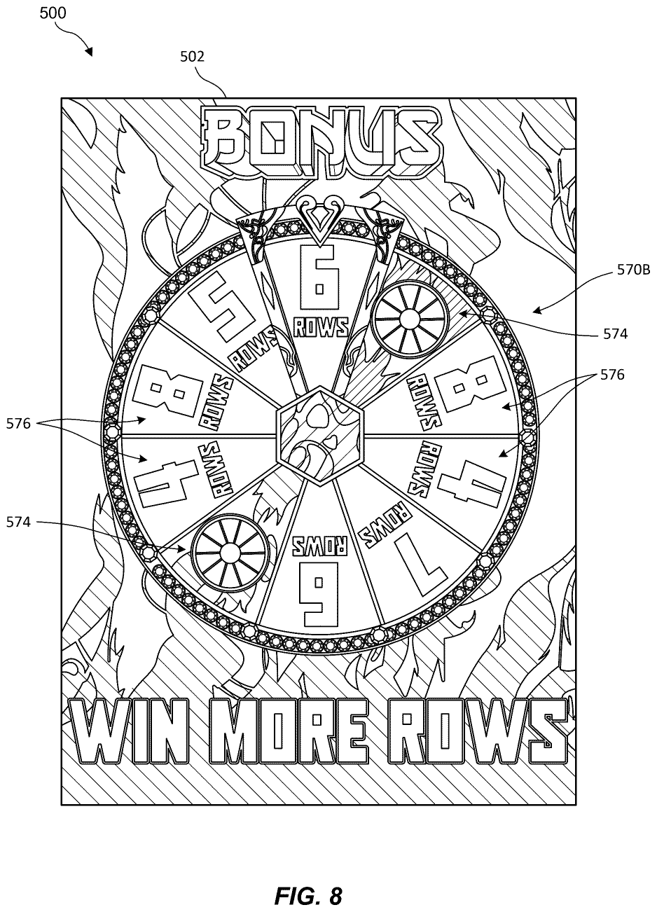

Referring to FIG. 8, second bonus wheel 570B may include second enhancement symbols 576 and additional bonus wheel symbols 574. Second enhancement symbols 576 may represent a number of rows to be used in the bonus game. An increased number of rows may provide the user with an increased chance of landing on winning symbols or combinations of symbols during the bonus game. Circuitry 404 (e.g., an RNG of circuitry 404) may randomly select which of second enhancement symbols 576 and, optionally, additional bonus wheel symbols 574 are landed during implementation of the bonus feature.

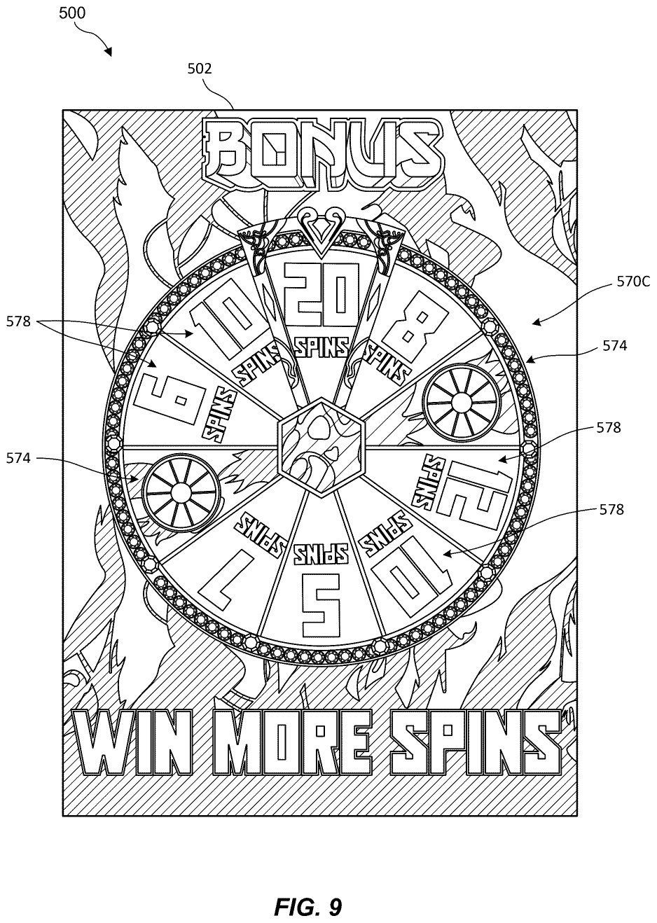

Referring to FIG. 9, third bonus wheel 570C may include third enhancement symbols 578 and additional bonus wheel symbols 574. Third enhancement symbols 578 may represent a number of spins to be played in the bonus game. An increased number of spins may provide the user with an increased number of chances to spin bonus reels in the bonus game, which in turn may improve the user's chance at landing on winning symbols or combinations of symbols during the bonus game. Circuitry 404 (e.g., an RNG of circuitry 404) may randomly select which of third enhancement symbols 578 and, optionally, additional bonus wheel symbols 574 are landed during implementation of the bonus feature.

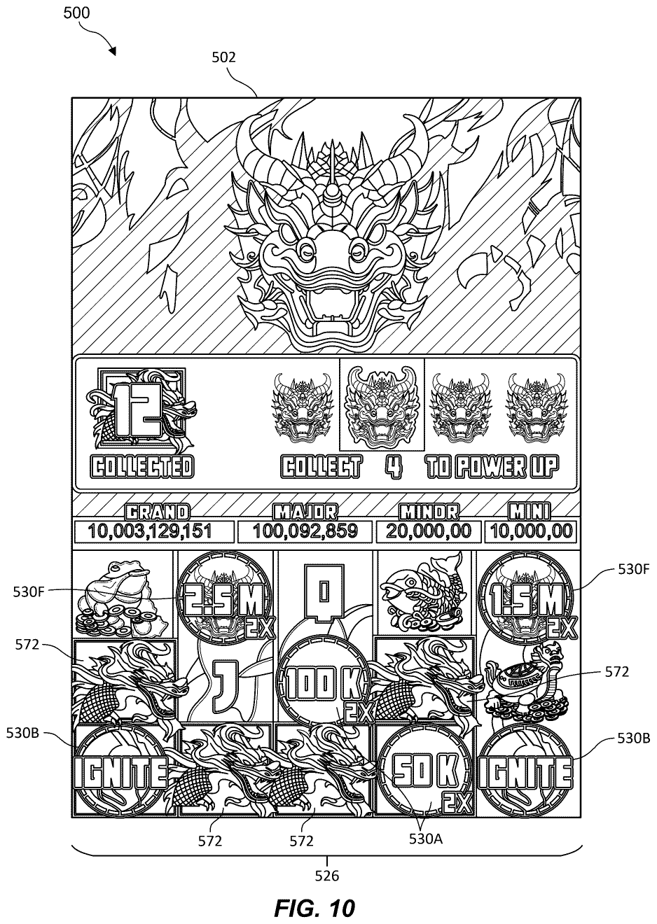

FIG. 10 depicts graphical interface 500 with a bonus game displayed on display device 502. In this example, the bonus game has been enhanced after first bonus wheel 570A (FIG. 7) was activated and a number of first enhancement symbols 572 for advancement toward improved chances for higher payouts were selected in connection with the first bonus wheel 570A. By way of illustration and example, eight first enhancement symbols 572 were selected by circuitry 404 and applied to the bonus game. As shown in the example of FIG. 10, four additional first enhancement symbols 572 were landed on reels 526, bringing the total number of first enhancement symbols 572 to twelve. The first enhancements may be tiered. For example, between zero and three first enhancement symbols 572 may result in no enhanced chances at higher payouts, between four and seven first enhancement symbols 572 may result in a first level of enhanced chances at higher payouts, between eight and eleven first enhancement symbols 572 may result in a second level of enhanced chances at higher payouts, between twelve and fifteen first enhancement symbols 572 may result in a third level of enhanced chances at higher payouts, between sixteen and nineteen first enhancement symbols 572 may result in a fourth level of enhanced chances at higher payouts, and twenty or more first enhancement symbols 572 may result in a fifth level of enhanced chances at higher payouts.

For example, when at least one super COR symbol 530F lands during the bonus game along with an at least one ignite symbol 530B, a super COR feature may be enhanced based on which level of enhanced chances at higher payouts has been achieved (e.g., correlating to the number of first enhancement symbols 572 collected). By way of example and not limitation, the levels of enhancement may result in an increased number of prizes (e.g., prizes 562 of FIG. 6) to be awarded, such as at least three prizes for level one, at least four prizes for level two, at least five prizes for level three, etc. Additionally or alternatively, the levels of enhancement may result in a potentially increased value of each awarded prize, such as a highest potential mini jackpot for level one, a highest potential minor jackpot for level two, a highest potential major jackpot for level three, an increased chance for a mini jackpot and a highest potential grand jackpot for level four, an increased chance for a minor jackpot and a highest potential grand jackpot at level five, etc.

Additionally or alternatively, depending on which of bonus wheels 570 are activated, the bonus game may be enhanced in response to second enhancement symbols 576 of second bonus wheel 570B and/or third enhancement symbols 578 of third bonus wheel 570C. As noted above, these enhancements may be applied individually (e.g., if only one of bonus wheels 570 was activated in connection with a bonus feature) or simultaneously (e.g., if more than one of bonus wheels 570 was activated in connection with a bonus feature) to the bonus game. For example, if second bonus wheel 570B was activated, reels 526 may be expanded to include at least one additional visible row of symbols, which may improve a chance of landing on winning symbols or combinations of symbols. If third bonus wheel 570C was activated, additional spins of reels 526 may be completed before the bonus game is ended.

In some examples, if multiple bonus wheels 570 are activated, weights used in combination with random number generation may change for one or more of the multiple bonus wheels 570 potential outcomes. For example, if first bonus wheel 570A and second bonus wheel 570B are both activated, an outcome of first bonus wheel 570A may result in adjusted weights for second bonus wheel 570B. In one example, if a player achieves a relatively low first enhancement from the first bonus wheel 570A, weights may be adjusted to increase a chance that the player achieves a relatively high second enhancement from the second bonus wheel 570B.

Referring again to FIG. 10, reels 526 may each have a predetermined layout of symbols 530, 572 thereon. In some examples, certain stacks of symbol positions on one or more of reels 526 may be used for potentially grouping similar symbols 530, 572. For example, three vertically adjacent positions on a single reel 526 may define to a stack of variable symbol positions. Circuitry 404, using random number generation, may determine that a maximum of three positions in the stack should be filled with a same symbol 530, 572. In another example, the stack of three variable symbol positions may be filled with one, two, or three same symbols 530, 572, depending on the maximum number of that symbol 530, 572 that should be landed as determined by circuitry 404 via random number generation. In this example, if circuitry 404 determines (e.g., based on random number generation) that a maximum of two first enhancement symbols 572 should be landed during a certain round of gameplay, the stack of three vertically adjacent positions should display two of first enhancement symbols 572 vertically adjacent to each other in the first two positions in the stack and another symbol (e.g., a different random symbol) in the third position of the stack. Groups of symbols 530, 572 may generally provide a more engaging experience for a player compared to a same number of symbols dispersed across reels 526. Accordingly, these examples of stacks of positions on reels 526 may result in a higher likelihood of grouping the same symbols 530, 572 together for more engaging gameplay.

FIG. 11A illustrates a weight table 1100, according to at least one embodiment of the present disclosure. Weight table 1100 may be used in conjunction with an RNG to determine how many steps a bonus feature trigger meter may be incremented in response to a triggering event, such as landing a bonus trigger symbol during a base game.

For example, weight table 1100 may be associated with a bonus feature trigger meter that has a capacity of nine steps (e.g., nine gems, etc.), with the first step being automatically filled when the bonus trigger meter is reset to its initial state. By way of illustration, if two of the nine gems are already filled in the bonus feature trigger meter during a round of gameplay and a bonus trigger symbol lands, an RNG may be used with the column labeled “2” of weight table 1100 to select how many additional gems are added to the bonus feature trigger meter. In this example, there may be a 64 in 127 chance that no levels are added to the bonus feature trigger meter, a 32 in 127 chance that one level is added, a 16 in 127 chance that two levels are added, an 8 in 127 chance that three levels are added, a 4 in 127 chance that four levels are added, a 2 in 127 chance that five levels are added, and a 1 in 127 chance that six levels are added. In additional examples, there may also be a chance that all seven remaining levels are added to fill the bonus feature trigger meter to its capacity, triggering a bonus feature. Optionally, this chance that all remaining levels are added to fill the bonus feature trigger meter may be governed by a separate weight table, or may be included among the weights in weight table 1100.

In another example, if six of nine gems are already filled in the bonus feature trigger meter during a round of gameplay and a bonus trigger symbol lands, the RNG may be used with the column labeled “6” of weight table 1100 to select how many additional levels are added to the bonus feature trigger meter. In this example, there may be a 4 in 7 chance that zero levels are added to the bonus feature trigger meter, a 2 in 7 chance that one level is added, and a 1 in 7 chance that two levels are added. In additional examples, there may also be a chance that all seven remaining levels are added to fill the bonus feature trigger meter to capacity, triggering a bonus feature. As noted above, optionally, this chance that all remaining levels are added to fill the bonus feature trigger meter may be governed by a separate weight table, or may be included among the weights in weight table 1100.

FIG. 11B illustrates three weight tables 1102, 1104, and 1106 according to at least one additional embodiment of the present disclosure. Weight tables 1102, 1104, 1106 may be used in conjunction with an RNG to determine the number and value of prizes to be awarded to a user based on a super COR level achieved during a round of gameplay. By way of illustration, as described above with reference to FIG. 6, two COR symbols 530A, two super COR symbols 530F, and at least one ignite symbol 530B may have landed to achieve a super COR level of two and triggering a payout with four prizes. In this example, weight table 1102 may first be used in conjunction with an RNG to determine how many of the four prizes awarded should be large COR prizes. For example, based on a 150,000 in 1,000,000 chance as shown in weight table 1102, the RNG may determine that two of the prizes awarded should be large COR prizes, with the remaining two prizes being normal COR prizes.

Next, weight table 1104 may be used in conjunction with the RNG to determine which two large COR prizes will be awarded. For example, based on the super COR level of two, the column labeled “2” of weight table 1104 may be used with an RNG to award two large COR prizes. In this case, there is a 500,000 in 930,000 chance for each large COR prize that a mini jackpot will be awarded, a 100,000 in 930,000 chance that five times the bet will be awarded, a 300,000 in 930,000 chance that a minor jackpot will be awarded, a 20,000 in 930,000 chance that ten times the bet will be awarded, and a 10,000 in 930,000 chance that twenty times the bet will be awarded. Based on the super COR level of two, there may be no chance that a major jackpot or a grand jackpot will be awarded as one of the large COR prizes.

Next, weight table 1106 may be used in conjunction with the RNG to determine which two normal COR prizes will be awarded. In this example, there is a 400,000 in 1,000,000 chance for each normal COR prize that half the bet will be awarded, a 400,000 in 1,000,000 chance that one times the bet will be awarded, a 180,000 in 1,000,000 chance that two times the bet will be awarded, and a 19,993 in 1,000,000 chance that three times the bet will be awarded. There is also a 1 in 1,000,000 chance for each normal COR prize to award each of a mini jackpot, a five times the bet award, a minor jackpot, a ten times the bet award, a twenty times the bet award, a major jackpot, or a grand jackpot.

The values in weight tables 1100, 1102, 1104, 1106 are provided by way of illustration and example. The present disclosure is not limited to these values, which can be altered to achieve a variety of outcomes. In some examples, different columns of weight tables 1100, 1102, 1104, 1106 may be selected and used during gameplay, such as in response to certain events. For example, an event (e.g., landing on a particular bonus symbol) may result in the selection of a weight table column that has an increased weight for a higher payout, which in turn may result in an increased likelihood that the higher payout may be attained. In another example, an event (e.g., already having landed on a particular symbol and achieving an associated award) may result in the selection of a weight table column with a weight changing to zero for a particular outcome to result in no chance that the associated outcome may occur. Additionally, the values of weight tables 1100, 1102, 1104, 1106 may be adjusted by a game designer to change the chance that certain modes of gameplay, awards, prizes, bonus features, etc., may become triggered.

Similarly, other weight tables may be used for a variety of different gameplay purposes, such as in connection with a base game, in connection with a bonus game, in connection with an enhancement feature, etc.

Accordingly, using weight tables in conjunction with an RNG, as outlined by way of example above, may be a technical solution to the technical problem of how to maintain randomness of outcomes, and also maintaining the return to player (RTP) within a predefined range, while providing an engaging player experience.

FIG. 12 is a flow diagram of an example computer-implemented method 1200 for triggering bonus features of electronic wagering games. In one example, the steps shown in FIG. 12 may be achieved and/or accomplished by an EGM and/or a server implementing an electronic wagering game. Additionally or alternatively, the steps shown in FIG. 1 may incorporate and/or involve certain sub-steps and/or variations consistent with the descriptions provided above in connection with FIGS. 1-11B.

At operation 1210 of method 1200, an event that triggers incrementing a bonus feature trigger meter may be detected. Operation 1210 may be performed in a variety of ways, including any of those described above in connection with FIGS. 1-11B. For example, circuitry may detect the event, such as landing at least one bonus trigger symbol on reels of the electronic wagering game and displayed on a display device.

At operation 1220, a random number of steps between zero steps and one less than all remaining steps to fill the bonus feature trigger meter may be determined. Operation 1220 may be performed in a variety of ways, including any of those described above in connection with FIGS. 1-11B. For example, the circuitry may determine the random number of steps based on detecting the event at operation 1210, the random number of steps using a random number generator. In some examples, the random number of steps may be weighted such that a lower number of steps has an increased probability compared to a higher number of steps.

At operation 1230, the bonus feature trigger meter may be incremented by the determined random number of steps. Operation 1230 may be performed in a variety of ways, including any of those described above in connection with FIGS. 1-11B. For example, the circuitry may increment the bonus feature trigger meter by the determined random number of steps.

At operation 1240, the display device may be caused to display the incremented bonus feature trigger meter. Operation 1240 may be performed in a variety of ways, including any of those described above in connection with FIGS. 1-11B. For example, the circuitry may direct a display device to render one or more visual effects corresponding to incrementing the bonus feature trigger meter. The visual effects may include, for example, highlighting one or more gems of a sequence of gems, increasing a size, amount, or intensity of flames, filling graphical bowls that fill with graphical coins, and/or other metamorphic visuals effects.

At operation 1250, the display device may be caused to display a bonus feature when the bonus feature trigger meter is filled. Operation 1250 may be performed in a variety of ways, including any of those described above with reference to FIGS. 1-11B. For example, an RNG may be used to determine that the bonus feature trigger meter should be filled to capacity, such as in connection with a weight table designed to provide a chance at filling the bonus feature trigger meter to capacity, after one or more bonus trigger symbol have landed on the reel. In response, the circuitry may cause the display device to display the bonus feature, such as in the form of a bonus wheel to select an enhancement and a bonus game with the enhancement applied. In some examples, more than one bonus wheel may be displayed (e.g., sequentially) on the display device, with more than one corresponding enhancement applied to the bonus game.

In some examples, one or more of the components and/or devices illustrated in FIGS. 1-11B need not be present to practice the embodiments described and/or illustrated herein. The devices and subsystems referenced above are also interconnected in different ways from those shown in FIGS. 1-11B. One or more of the devices and/or subsystems may be employed in any number of software, firmware, and/or hardware configurations. For example, one or more of the embodiments disclosed herein may be encoded as a computer program (also referred to as computer software, software applications, computer-readable instructions, or computer control logic) on a computer-readable medium. The term “computer-readable medium,” as used herein, refers to any form of device, carrier, or medium capable of storing or carrying computer-executable and/or computer-readable instructions. Examples of computer-readable media include, without limitation, transmission-type media, such as carrier waves, and non-transitory-type media, such as magnetic-storage media (e.g., hard disk drives, tape drives, etc.), optical-storage media (e.g., Compact Disks (CDs), Digital Video Disks (DVDs), and BLU-RAY disks), electronic-storage media (e.g., solid-state drives and flash media), and other digital storage systems.

A computer-readable medium containing a computer program may be loaded into one of the devices and/or subsystems in FIGS. 1-10. All or a portion of the computer program stored on the computer-readable medium is then stored in memory and/or a storage device. When executed by a physical processor, a computer program loaded into the memory causes the physical processor to perform and/or be a means for performing the functions of one or more of the embodiments described and/or illustrated herein. Additionally or alternatively, one or more of the embodiments described and/or illustrated herein may be implemented in firmware and/or hardware. For example, one or more of the devices and/or subsystems in FIGS. 1-10 may be configured as an ASIC adapted to implement one or more of the example embodiments disclosed herein.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

In some examples, the term “memory device” generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In some examples, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

The preceding description has been provided to enable others skilled in the art to best utilize various aspects of the example embodiments disclosed herein. This example description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference may be made to any claims appended hereto and their equivalents in determining the scope of the present disclosure.

Unless otherwise noted, the terms “connected to” and “coupled to” (and their derivatives), as used in the specification and/or claims, are to be construed as permitting both direct and indirect (i.e., via other elements or components) connection. In addition, the terms “a” or “an,” as used in the specification and/or claims, are to be construed as meaning “at least one of.” Finally, for ease of use, the terms “including” and “having” (and their derivatives), as used in the specification and/or claims, are interchangeable with and have the same meaning as the word “comprising.”

What is claimed is:

1. A system, comprising:
a display device; and
circuitry configured to:
detect, in a base game of an electronic wagering game displayed on the display device, an event that triggers incrementing a bonus feature trigger meter;
based on detecting the event, determine a random number of steps between zero steps and one less than all remaining steps to fill the bonus feature trigger meter;
increment the bonus feature trigger meter by the determined random number of steps;
cause the display device to display the incremented bonus feature trigger meter; and
when the bonus feature trigger meter is filled, cause the display device to display a bonus feature.

2. The system of claim 1, wherein the circuitry is further configured to, in connection with the base game:
cause the display device to display random symbols from a set of symbols on one or more reels of the electronic wagering game.

3. The system of claim 2, wherein the event that triggers incrementing the bonus feature trigger meter comprises the display device displaying at least one of the random symbols that is a bonus symbol.

4. The system of claim 2, wherein the one or more reels comprises at least three reels.

5. The system of claim 2, wherein the circuitry is further configured to, in connection with the base game:
cause the electronic wagering game to credit to a user one or more values represented by one or more award symbols of the random symbols displayed on the one or more reels by the display device.

6. The system of claim 1, wherein causing the display device to display the bonus feature comprises causing the display device to:
display a bonus wheel including enhancement symbols; and
randomly select one or more of the enhancement symbols of the bonus wheel.

7. The system of claim 6, wherein the circuitry is further configured to, after randomly selecting the one or more enhancement symbols:
cause the display device to display a bonus game with one or more enhancements applied corresponding to the selected one or more enhancement symbols of the bonus wheel.

8. A system comprising:
a display device; and
circuitry configured to:
detect, in a base game of an electronic wagering game displayed on the display device, one or more random events that trigger incrementing at least one of a first trigger meter for a first bonus feature or a second trigger meter for a second bonus feature;
based on detecting the one or more random events, increment the first trigger meter until the first trigger meter is filled to trigger the first bonus feature;
when the first bonus feature is triggered, cause the display device to display first enhancement symbols including at least one activation symbol to activate the second bonus feature;
when the second bonus feature is activated, cause the display device to display second enhancement symbols;
determine a random one of the first enhancement symbols of the first bonus feature for selection; and
cause the display device to display a bonus game with a first enhancement based on the selected one of the first enhancement symbols applied.

9. The system of claim 8, wherein causing the display device to display the first enhancement symbols comprises causing the display device to display a first bonus wheel including the first enhancement symbols.

10. The system of claim 8, wherein the circuitry is further configured to:
when the second bonus feature is activated, randomly select one of the second enhancement symbols of the second bonus feature; and
cause the display device to display the bonus game with a second enhancement based on the selected one of the second enhancement symbols applied.

11. The system of claim 8, wherein the first enhancement symbols include symbols representing one of: advancement toward improved chances for higher payouts in the bonus game, one or more additional rows of bonus symbols in the bonus game, or one or more additional rounds of the bonus game.

12. The system of claim 11, wherein the second enhancement symbols include symbols representing a different one of: the advancement toward improved chances for higher payouts in the bonus game, the one or more additional rows of bonus symbols in the bonus game, or the one or more additional rounds of the bonus game.

13. The system of claim 8, wherein the circuitry is further configured to, in connection with the bonus game:
cause the display device to display random symbols from a set of bonus symbols on one or more bonus reels of the electronic wagering game.

14. A computer-implemented method, comprising:
detecting, by circuitry during a base game of an electronic wagering game displayed on a display device, an event that triggers incrementing a bonus feature trigger meter;
determining, by the circuitry and based on detecting the event, a random number of steps between zero steps and one less than all remaining steps to fill the bonus feature trigger meter;
incrementing, by the circuitry, the bonus feature trigger meter by the determined random number of steps;
causing, by the circuitry, the display device to display the incremented bonus feature trigger meter; and
causing, by the circuitry and when the bonus feature trigger meter is filled, the display device to display a bonus feature.

15. The method of claim 14, wherein causing the display device to display the bonus feature comprises causing, by the circuitry, the display device to:
display a bonus wheel including enhancement symbols; and
randomly select one or more of the enhancement symbols of the bonus wheel.

16. The method of claim 15, further comprising, after randomly selecting the one or more enhancement symbols, causing, by the circuitry, the display device to display a bonus game with one or more enhancements applied corresponding to the selected one or more enhancement symbols of the bonus wheel.

17. The method of claim 14, wherein causing the display device to display the bonus feature comprises:
causing, by the circuitry, the display device to display first enhancement symbols including at least one activation symbol to activate an additional bonus feature;
causing, by the circuitry and when the additional bonus feature is activated, the display device to display second enhancement symbols;
determining, by the circuitry, a random one of the first enhancement symbols of the bonus feature for selection; and
causing, by the circuitry, the display device to display a bonus game with a first enhancement based on the selected one of the first enhancement symbols applied.

18. The method of claim 17, further comprising:
when the second bonus feature is activated, randomly selecting, by the circuitry, one of the second enhancement symbols of the additional bonus feature; and
causing, by the circuitry, the display device to display the bonus game with a second enhancement based on the selected one of the second enhancement symbols applied.

19. The method of claim 17, wherein the first enhancement symbols include symbols representing one of: advancement toward improved chances for higher payouts in the bonus game, one or more additional rows of bonus symbols in the bonus game, or one or more additional rounds of the bonus game.

20. The method of claim 19, wherein the second enhancement symbols include symbols representing a different one of: the advancement toward improved chances for higher payouts in the bonus game, the one or more additional rows of bonus symbols in the bonus game, or the one or more additional rounds of the bonus game.
